(19) United States
(12) Patent Application Publication
(10) Pub. No.: US 2025/0314857 A1
(43) Pub. Date: Oct. 9, 2025

(54) OPTICAL SYSTEM

(71) Applicant: FUJIFILM Corporation, Tokyo (JP)

(72) Inventors: Ryoko TOMIOKA, Saitama-shi (JP); Hiroki SAITO, Saitama-shi (JP)

(73) Assignee: FUJIFILM Corporation, Tokyo (JP)

(21) Appl. No.: 19/242,958

(22) Filed: Jun. 18, 2025

Related U.S. Application Data
(63) Continuation of application No. PCT/JP2023/040636, filed on Nov. 10, 2023.

(30) Foreign Application Priority Data
Dec. 26, 2022 (JP) 2022-209062

(51) Int. Cl. G02B 9/64; G02B 13/00; G02B 13/02

(52) U.S. Cl. CPC G02B 9/64; G02B 13/0045; G02B 13/006; G02B 13/02

(57) ABSTRACT

An optical system includes at least one lens component, in which in a case in which a distance, on an optical axis, from a lens surface of the optical system closest to an object side to a lens surface of the optical system closest to an image side is denoted by TD, and the lens component, in which at least a part of the lens component is located in a range of 0.3×TD from the lens surface of the optical system closest to the object side to the image side on the optical axis, among the lens components included in the optical system is defined as a front lens component, a film having a light reflectivity of less than 30% is provided on 50% or more of a total area of edge surfaces of all the front lens components.

### CROSS-REFERENCE TO RELATED APPLICATIONS

This application is a continuation application of International Application No. PCT/JP2023/040636, filed on Nov. 10, 2023, which claims priority from Japanese Patent Application No. 2022-209062, filed on Dec. 26, 2022. The entire disclosure of each of the above applications is incorporated herein by reference.

### BACKGROUND

### Technical Field

The technology of the present disclosure relates to an optical system.

### Related Art

JP2015-028552A discloses an optical element comprising an antireflection structure consisting of a fine uneven structure having a wavelength equal to or less than a used wavelength in at least a part of a ray effective portion. JP2015-148829A discloses a plastic lens held by a holding portion, the plastic lens comprising a first edge portion that has a first outer peripheral edge surface formed substantially parallel to a lens optical axis and that is held by the holding portion, and a second edge portion that has a second outer peripheral edge surface formed to have a step with respect to the first outer peripheral edge surface, in which a black paint that suppresses internal surface reflection of light is not applied to the first outer peripheral edge surface, and the black paint that suppresses the internal surface reflection of light is applied to at least a part of the second outer peripheral edge surface.

### SUMMARY

In a case in which an optical system such as an imaging lens is observed from an object side and/or an image side, an outer peripheral surface of a lens of the optical system, particularly an outer peripheral surface parallel to an optical axis, is visually recognized by external light, and the quality of the appearance may be impaired.

An object of the present disclosure is to provide an optical system having a high-quality appearance. In addition, another object is to maintain good performance.

A first aspect of the present disclosure relates to an optical system comprising: at least one lens component in a case in which one lens component is one single lens or one cemented lens, in which in a case in which an outer peripheral surface of the lens component parallel to an optical axis is defined as an edge surface, a distance, on the optical axis, from a lens surface of the optical system closest to an object side to a lens surface of the optical system closest to an image side is denoted by TD, and the lens component, in which at least a part of the lens component is located in a range of 0.3×TD from the lens surface of the optical system closest to the object side to the image side on the optical axis, among the lens components included in the optical system is defined as a front lens component, a film having a light reflectivity of less than 30% is provided on 50% or more of a total area of the edge surfaces of all the front lens components.

In the optical system according to the first aspect, in which in a case in which an open F-number of the optical system in a state in which an infinite distance object is in focus is denoted by FNo, a maximum half angle of view of the optical system in a state in which the infinite distance object is in focus is denoted by ω, and FNo and ω are values at a wide angle end in a case in which the optical system is a variable magnification optical system, it is preferable that Conditional Expression (1) is satisfied, which is represented by 1<FNo/tan ω<10 (1).

In the optical system according to the first aspect, in a case in which an intersection between the lens surface of the optical system closest to the object side and the optical axis is defined as a front intersection, and for each of the front lens components, an angle between a line connecting the front intersection and a point of the edge surface closest to the object side and the optical axis is denoted by αf, an angle between a line connecting the front intersection and a point of the edge surface closest to the image side and the optical axis is denoted by βf, and units of αf and βf are degrees, it is preferable that the film is provided on 50% or more of a total area of the edge surfaces of all the front lens components satisfying Conditional Expression (2), which is represented by 2.7°<αf−βf<40° (2).

In the optical system according to the first aspect, in a case in which an intersection between the lens surface of the optical system closest to the object side and the optical axis is defined as a front intersection, N is defined as a natural number of 2 or more, and for an N-th front lens component from the object side, an angle between a line connecting the front intersection and a point of the edge surface closest to the object side and the optical axis is denoted by αf, an angle between a line connecting the front intersection and a point of the edge surface closest to the image side and the optical axis is denoted by βf, units of αf and βf are degrees, and a composite focal length from the front lens component closest to the object side to an (N−1)th front lens component from the object side is denoted by ff, it is preferable that a proportion of an area on which the film is provided is 30% or less of a total area of the edge surfaces of all the front lens components satisfying Conditional Expressions (3) and (4), which are represented by 1.1°<αf−βf≤2.7° (3), and −2.4<TD/ff (4).

In the optical system according to the first aspect, in a case in which an intersection between the lens surface of the optical system closest to the object side and the optical axis is defined as a front intersection, N is defined as a natural number of 2 or more, and for an N-th front lens component from the object side, an angle between a line connecting the front intersection and a point of the edge surface closest to the object side and the optical axis is denoted by αf, an angle between a line connecting the front intersection and a point of the edge surface closest to the image side and the optical axis is denoted by βf, units of αf and βf are degrees, and a paraxial curvature radius of a surface, which is closest to the image side, of the N-th front lens component from the object side is denoted by Rf, it is preferable that a proportion of an area on which the film is provided is 30% or less of a total area of the edge surfaces of all the front lens components satisfying Conditional Expressions (3) and (5), which are represented by 1.1°<αf−βf≤2.7° (3), and TD/Rf<2.4 (5).

In the optical system according to the first aspect, in a case in which an intersection between the lens surface of the optical system closest to the object side and the optical axis is defined as a front intersection, for each of the front lens components, an angle between a line connecting the front intersection and a point of the edge surface closest to the object side and the optical axis is denoted by αf, an angle between a line connecting the front intersection and a point of the edge surface closest to the image side and the optical axis is denoted by βf, and units of αf and βf are degrees, the lens component, in which at least a part of the lens component is located in a range of 0.3×TD from the lens surface of the optical system closest to the image side to the object side on the optical axis, among the lens components included in the optical system is defined as a rear lens component, an intersection between the lens surface of the optical system closest to the image side and the optical axis is defined as a rear intersection, and for each of the rear lens components, an angle between a line connecting the rear intersection and a point of the edge surface closest to the image side and the optical axis is denoted by αr, an angle between a line connecting the rear intersection and a point of the edge surface closest to the object side and the optical axis is denoted by Br, and units of αr and βr are degrees, it is preferable that a proportion of an area on which the film is provided is 30% or less of a total area of the edge surfaces of all the front lens components satisfying Conditional Expression (10) and the edge surfaces of all the rear lens components satisfying Conditional Expression (11), Conditional Expressions (10) and (11) being represented by 0°<αf−βf≤1.1° (10), and 0°<αr βr≤1.1° (11).

A second aspect of the present disclosure relates to an optical system comprising: at least one lens component in a case in which one lens component is one single lens or one cemented lens, in which in a case in which an outer peripheral surface of the lens component parallel to an optical axis is defined as an edge surface, a distance, on the optical axis, from a lens surface of the optical system closest to an object side to a lens surface of the optical system closest to an image side is denoted by TD, and the lens component, in which at least a part of the lens component is located in a range of 0.3×TD from the lens surface of the optical system closest to the image side to the object side on the optical axis, among the lens components included in the optical system is defined as a rear lens component, a film having a light reflectivity of less than 30% is provided on 50% or more of a total area of the edge surfaces of all the rear lens components.

In the optical system according to the second aspect, in a case in which an intersection between the lens surface of the optical system closest to the image side and the optical axis is defined as a rear intersection, and for each of the rear lens components, an angle between a line connecting the rear intersection and a point of the edge surface closest to the image side and the optical axis is denoted by αr, an angle between a line connecting the rear intersection and a point of the edge surface closest to the object side and the optical axis is denoted by βr, and units of αr and βr are degrees, it is preferable that the film is provided on 50% or more of a total area of the edge surfaces of all the rear lens components satisfying Conditional Expression (6), which is represented by 2.7°<αr−βr<40° (6).

In the optical system according to the second aspect, in a case in which an intersection between the lens surface of the optical system closest to the image side and the optical axis is defined as a rear intersection, M is defined as a natural number of 2 or more, and for an M-th rear lens component from the image side, an angle between a line connecting the rear intersection and a point of the edge surface closest to the image side and the optical axis is denoted by αr, an angle between a line connecting the rear intersection and a point of the edge surface closest to the object side and the optical axis is denoted by βr, units of αr and βr are degrees, and a composite focal length from the rear lens component closest to the image side to an (M−1)th rear lens component from the image side is denoted by fr, it is preferable that a proportion of an area on which the film is provided is 30% or less of a total area of the edge surfaces of all the rear lens components satisfying Conditional Expressions (7) and (8), which are represented by 1.1°<αr−βr≤2.7° (7), and −2.4<TD/fr (8).

In the optical system according to the second aspect, in a case in which an intersection between the lens surface of the optical system closest to the image side and the optical axis is defined as a rear intersection, M is defined as a natural number of 2 or more, and for an M-th rear lens component from the image side, an angle between a line connecting the rear intersection and a point of the edge surface closest to the image side and the optical axis is denoted by αr, an angle between a line connecting the rear intersection and a point of the edge surface closest to the object side and the optical axis is denoted by βr, units of αr and βr are degrees, and a paraxial curvature radius of a surface, which is closest to the object side, of the M-th rear lens component from the image side is denoted by Rr, it is preferable that a proportion of an area on which the film is provided is 30% or less of a total area of the edge surfaces of all the rear lens components satisfying Conditional Expressions (7) and (9), which are represented by 1.1°<αr−βr≤2.7° (7), and −10<TD/Rr (9).

In the optical system according to the second aspect, in a case in which the lens component, in which at least a part of the lens component is located in a range of 0.3×TD from the lens surface of the optical system closest to the object side to the image side on the optical axis, among the lens components included in the optical system is defined as a front lens component, an intersection between the lens surface of the optical system closest to the object side and the optical axis is defined as a front intersection, for each of the front lens components, an angle between a line connecting the front intersection and a point of the edge surface closest to the object side and the optical axis is denoted by αf, an angle between a line connecting the front intersection and a point of the edge surface closest to the image side and the optical axis is denoted by βf, and units of αf and βf are degrees, an intersection between the lens surface of the optical system closest to the image side and the optical axis is defined as a rear intersection, and for each of the rear lens components, an angle between a line connecting the rear intersection and a point of the edge surface closest to the image side and the optical axis is denoted by αr, an angle between a line connecting the rear intersection and a point of the edge surface closest to the object side and the optical axis is denoted by βr, and units of αr and βr are degrees, it is preferable that a proportion of an area on which the film is provided is 30% or less of a total area of the edge surfaces of all the front lens components satisfying Conditional Expression (10) and the edge surfaces of all the rear lens components satisfying Conditional Expression (11), Conditional Expressions (10) and (11) being represented by 0°<αf−βf≤1.1° (10), and 0°<αr−βr≤1.1° (11).

In the optical system according to the above-described aspects, the optical system may include, in order from the object side to the image side, a first lens group having a positive refractive power and a subsequent group including at least one lens group, and a spacing between adjacent lens groups may change during changing magnification. The subsequent group may include a second lens group having a negative refractive power at a position closest to the object side. The subsequent group may include, in successive order from the object side to the image side, the second lens group, a third lens group, and a fourth lens group, and at least the second lens group and the fourth lens group may move during changing magnification. The subsequent group may include a focusing group that moves along the optical axis during focusing.

The “focal length” used in the conditional expressions is a paraxial focal length. Unless otherwise noted, the “distance on the optical axis” used in the conditional expressions is a geometrical distance. Unless otherwise noted, the values used in the conditional expressions are values based on a d line in a state in which the infinite distance object is in focus. A sign of a curvature radius of a surface having a convex shape facing the object side is defined as positive, and a sign of a paraxial curvature radius of a surface having a convex shape facing the image side is defined as negative. The “d line”, a “C line”, and an “F line” described in the present specification are emission lines, a wavelength of the d line is 587.56 nanometers (nm), a wavelength of the C line is 656.27 nanometers (nm), and a wavelength of the F line is 486.13 nanometers (nm).

According to the present disclosure, it is possible to provide the optical system having a high-quality appearance.

### BRIEF DESCRIPTION OF THE DRAWINGS

FIG. 1 is a cross-sectional view showing a configuration of an optical system according to one embodiment, which corresponds to an optical system according to Example 1.

FIG. 2 is a diagram showing an edge surface.

FIG. 3 is a cross-sectional view showing a configuration and a luminous flux of the optical system in FIG. 1.

FIG. 4 is a partially enlarged view in a case in which a parallel luminous flux is incident to the optical system of FIG. 1.

FIG. 5 is a diagram showing symbols of conditional expressions.

FIG. 6 is a diagram showing the symbols of the conditional expressions.

FIG. 7 is each aberration diagram of the optical system according to Example 1.

FIG. 8 is a cross-sectional view showing a configuration of an optical system of Example 2.

FIG. 9 is each aberration diagram of the optical system according to Example 2.

FIG. 10 is a cross-sectional view showing a configuration of an optical system according to Example 3.

FIG. 11 is each aberration diagram of the optical system according to Example 3.

FIG. 12 is a cross-sectional view showing a configuration of an optical system according to Example 4.

FIG. 13 is each aberration diagram of the optical system according to Example 4.

FIG. 14 is a cross-sectional view showing a configuration of an optical system according to Example 5.

FIG. 15 is each aberration diagram of the optical system according to Example 5.

### DETAILED DESCRIPTION

Hereinafter, an embodiment of the present disclosure will be described with reference to the accompanying drawings.

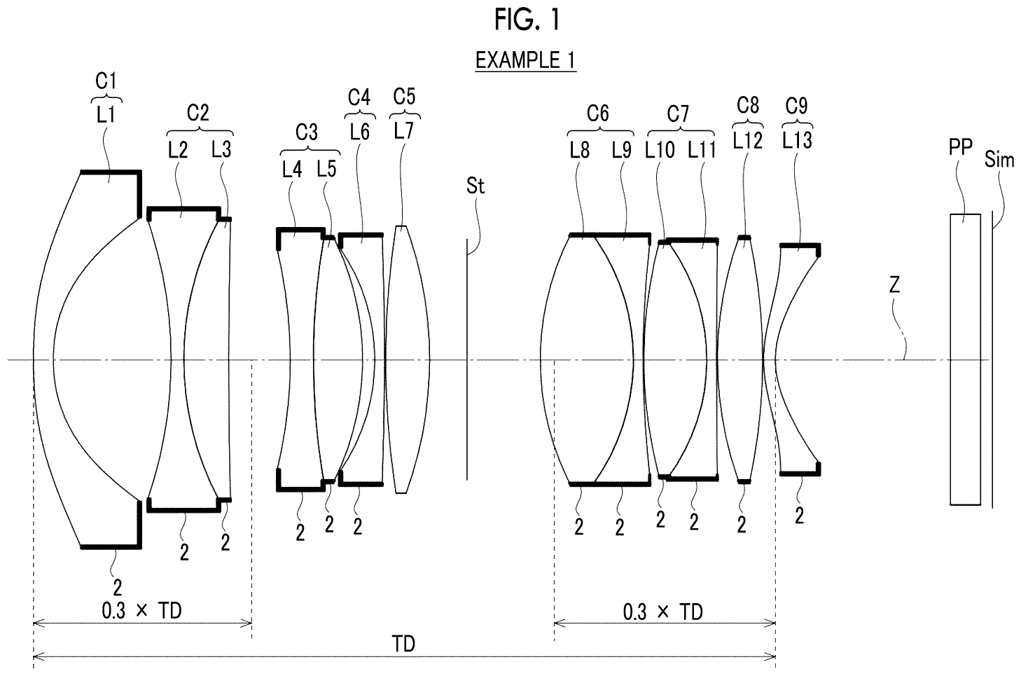

FIG. 1 shows a diagram of a configuration of an optical system according to the embodiment of the present disclosure in a cross section including an optical axis Z. In FIG. 1, a left side is an object side, and a right side is an image side. The example shown in FIG. 1 corresponds to an optical system according to Example 1 described below. The optical system of FIG. 1 can be used, for example, as an imaging lens for a digital camera.

The optical system according to the present disclosure includes at least one lens component. In the present specification, one single lens or one cemented lens is one lens component. The single lens is one lens that is not cemented.

For example, the optical system in FIG. 1 comprises nine lens components, that is, lens components C1 to C9 arranged in this order from the object side to the image side along the optical axis Z. In the optical system of FIG. 1, the lens component C1 is a lens component closest to the object side, and the lens component C9 is a lens component closest to the image side. An aperture stop St is disposed between the lens component C5 and the lens component C6. The aperture stop St shown in FIG. 1 does not indicate a size and a shape, and indicates a position in an optical axis direction.

Each lens component in the example in FIG. 1 has the following configuration. The lens component C1 is composed of a lens L1 that is a single lens. The lens component C2 is composed of a cemented lens in which a lens L2 and a lens L3 are cemented. The lens component C3 is composed of a cemented lens in which a lens L4 and a lens L5 are cemented. The lens component C4 is composed of a lens L6 that is a single lens. The lens component C5 is composed of a lens L7 that is a single lens. The lens component C6 is composed of a cemented lens in which a lens L8 and a lens L9 are cemented. The lens component C7 is composed of a cemented lens in which a lens L10 and a lens L11 are cemented. The lens component C8 is composed of a lens L12 that is a single lens. The lens component C9 is composed of a lens L13 that is a single lens.

It should be noted that, in the example of FIG. 1 shows an example in which a parallel flat plate-shaped optical member PP is disposed between the lens closest to the image side and an image plane Sim, assuming that the optical system is applied to an imaging apparatus. The optical member PP is a member assumed to be various filters and/or a cover glass. The various filters include a low-pass filter, an infrared cut filter, and/or a filter that cuts a specific wavelength range. The optical member PP is a member having no refractive power. The imaging apparatus can also be configured without using the optical member PP.

In the optical system such as the imaging lens, in a case in which the optical system is observed from the object side or the image side, an outer peripheral surface of the lens, particularly an outer peripheral surface parallel to the optical axis Z, may be visually recognized due to external light, which may impair the quality of the appearance. Therefore, in the technology of the present disclosure, a film 2 for suppressing light reflection is provided on the outer peripheral surface of the predetermined lens. Since it is desirable that the reflectivity is low in order to suppress the internal reflection and to make the outer peripheral surface of the lens inconspicuous in a case of being observed from the object side, the film 2 is formed such that the light reflectivity is less than 30%. The “light reflectivity is less than 30%” means that an average value of a reflectivity of an interface between the lens surface and the film 2 in a wavelength range of 400 to 700 nm is less than 30%. The reflectivity of the film 2 is preferably less than 25%, more preferably less than 20%, still more preferably less than 15%, and still more preferably less than 10%. The reflectivity of the film 2 can be measured by, for example, using a Microspectrophotometer USPM-RU manufactured by Olympus Corporation.

As the film 2, for example, a black paint can be used. Specifically, as the film 2, GT-7II Fine manufactured by Canon Chemicals Inc., GT-1000 manufactured by Canon Chemicals Inc., Macron for lens black coating manufactured by FIT Corporation, Epoxy Ink 1000 manufactured by Seiko advance Ltd., and the like can be used.

In FIG. 1, the film 2 is shown in an emphasized manner for easy understanding, and a thickness of the film 2 in FIG. 1 is not accurate. In addition, in the example of FIG. 1, the film 2 is provided on the outer peripheral surface in a circumferential direction including an upper side and a lower side of the optical axis Z, but in order to prevent the drawing from being complicated, reference numerals are attached only to the film 2 below the optical axis Z. The same applies to the other drawings in which the film 2 is shown in this manner.

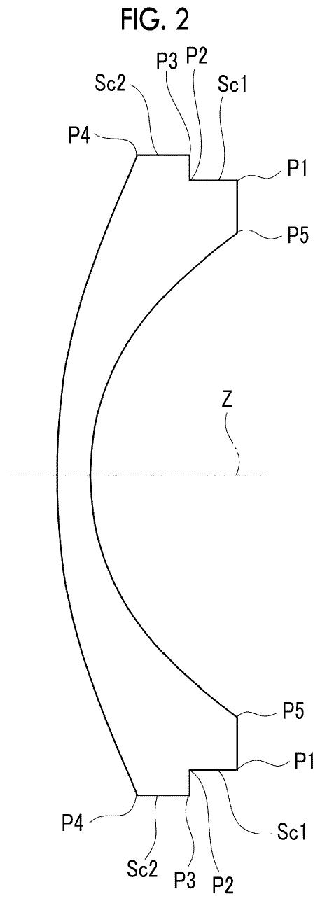

The film 2 is mainly provided on an edge surface. In the present specification, an outer peripheral surface parallel to the optical axis Z in the lens and the lens component will be referred to as the edge surface. The “outer peripheral surface parallel to the optical axis Z” described herein refers to an outer peripheral surface that appears parallel to the optical axis Z in a cross section including the optical axis Z. The outer peripheral surface of the lens will be described with reference to FIG. 2.

FIG. 2 shows a cross-sectional view of the lens in the cross section including the optical axis Z. In FIG. 2, a left side is the object side, and a right side is the image side. The lens of FIG. 2 is formed to be rotationally symmetric with respect to the optical axis Z as a symmetry axis, and has a stepped shape on the outer peripheral surface. In FIG. 2, for the sake of description, five points from a point P1 to a point P5 are shown as points on the cross section of the lens.

A region from the point P1 to the point P2 in FIG. 2 is the outer peripheral surface parallel to the optical axis Z, and is an edge surface Sc1. A region from the point P3 to the point P4 is also the outer peripheral surface parallel to the optical axis Z, and is an edge surface Sc2. As in the example of FIG. 2, in a case in which one lens has a plurality of outer peripheral surfaces parallel to the optical axis Z, all the plurality of outer peripheral surfaces parallel to the optical axis Z will be referred to as the edge surfaces.

A region from the point P1 to the point P5 and a region from the point P2 to the point P3 in FIG. 2 are the outer peripheral surfaces perpendicular to the optical axis Z. In the present specification, the outer peripheral surface perpendicular to the optical axis Z will be referred to as a flat chamfered surface.

It should be noted that “parallel” and “perpendicular” in the description of the present specification include an error generally allowed in the technical field to which the technology of the present disclosure belongs. The parallelism error is in a range in which an inclination angle with respect to the optical axis Z is −5 degrees or more and +5 degrees or less, preferably in a range in which the inclination angle is −3 degrees or more and +3 degrees or less, and more preferably in a range in which the inclination angle is −1 degrees or more and +1 degrees or less. The smaller the parallelism error, the more advantageous it is for the high-precision assembly of the optical system.

It is conceivable that the film 2 is provided in all the lens components, but, in a case in which the film 2 is provided, the number of manufacturing steps is increased as compared with a case in which the film 2 is not provided, so that fewer lens components provided with the film 2 are more advantageous for cost reduction. In addition, since the film 2 is provided in the lens component, the film 2 is formed on the outer peripheral surface of the lens, so that, in a case in which the thickness of the film 2 is non-uniform, there is a possibility that eccentricity may occur. Therefore, in a case in which a high-quality appearance is desired, the film 2 need not be provided for the lens component that does not cause any problem in appearance. A range in which the film 2 is provided will be described below.

First, a case will be described in which the optical system is observed from the object side. In a case in which the optical system is observed from the object side, the edge surface of the lens closer to the object side is almost visually recognized. In addition, in a case in which a lens length is denoted by TD, a range of 0.3×TD from the lens surface of the optical system closest to the object side to the image side on the optical axis is a range that is easily visually recognized in a case in which the optical system is observed from the object side. It should be noted that TD is defined as a distance, on the optical axis, from the lens surface of the optical system closest to the object side to the lens surface of the optical system closest to the image side. For example, FIG. 1 shows the lens length TD.

For convenience of description, a range from the lens surface of the optical system closest to the object side to the image side to 0.3×TD will be referred to as a “front visual recognition range”. In the example of FIG. 1, among two ranges indicated by “0.3×TD”, a range indicated by “0.3×TD” on the object side corresponds to the front visual recognition range.

Among the lens components included in the optical system, a lens component in which at least a part of the lens component is located in the front visual recognition range on the optical axis will be referred to as a “front lens component”. That is, among the lens components included in the optical system, a lens component in which a surface of the lens component closest to the object side is located in the front visual recognition range on the optical axis will be referred to as the “front lens component”. In the example of FIG. 1, the lens component C1 and the lens component C2 each correspond to the front lens component.

In the technology of the present disclosure, the film 2 is provided on 50% or more of a total area of the edge surfaces of all the front lens components. With this configuration, it is possible to reduce a situation in which the edge surface is visually recognized in a case in which the optical system is observed from the object side, and thus it is possible to maintain a high-quality appearance. In addition, by providing the film 2 on the edge surface, it is possible to suppress ghosts and flares caused by reflection inside the optical system, which can contribute to maintaining favorable performance.

In order to maintain a higher-quality appearance, it is preferable that the film 2 is provided on 60% or more of the total area of the edge surfaces of all the front lens components, it is more preferable that the film 2 is provided on 65% or more thereof, and it is still more preferable that the film 2 is provided on 75% or more thereof.

In the example of FIG. 1, the total area of the edge surfaces of the front lens components is a sum of the areas of the edge surfaces of all the lenses L1 to L3. In the example of FIG. 1, since the film 2 is provided on the entire surface of the edge surfaces of the lenses L1 to L3, the film 2 is provided on 100% of the total area of the edge surface of the front lens component.

It should be noted that the film 2 may be provided on the outer peripheral surface other than the edge surface and/or the outer peripheral surface of the lens component other than the front lens component, depending on the specifications required for the optical system. For example, in the example of FIG. 1, the film 2 is also provided on the flat chamfered surface of the lens L1 and the flat chamfered surface of the lens L2. In the example of FIG. 1, the film 2 is provided on the outer peripheral surfaces of the lens component C3 and the lens component C4. In addition, by providing the film 2 on the outer peripheral surface, it is possible to suppress ghosts and flares caused by reflection inside the optical system, which can contribute to maintaining favorable performance.

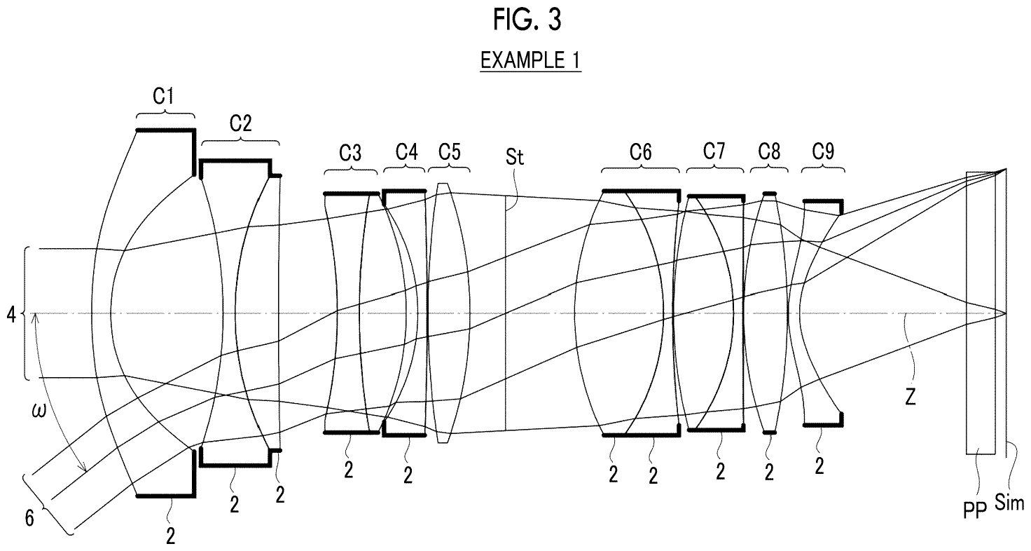

It is preferable that the optical system according to the present disclosure is an optical system that satisfies Conditional Expression (1). Here, an open F-number of the optical system in a state in which an infinite distance object is in focus is denoted by FNo. A maximum half angle of view of the optical system in a state in which the infinite distance object is in focus is denoted by ω. Here, tan indicates a tangent. In a case in which the optical system is a variable magnification optical system, FNo and o are values at a wide angle end. For example, FIG. 3 shows the maximum half angle of view ω. FIG. 3 is a diagram showing an on-axis luminous flux 4 and an off-axis luminous flux 6 having the maximum half angle of view ω in combination in the cross-sectional view of the optical system of FIG. 1.

1<FNo/tan ω<10 (1)

With the optical system according to the present disclosure, by not allowing the corresponding value of Conditional Expression (1) to be equal to or more than the upper limit, it is possible to achieve an optical system having a high-quality appearance while ensuring a small open F-number and/or a wide angle of view.

By not allowing the corresponding value of Conditional Expression (1) to be equal to or less than the lower limit, it is easy to suppress an increase in the number of lenses and to suppress an increase in the size of the optical system while obtaining favorable optical performance.

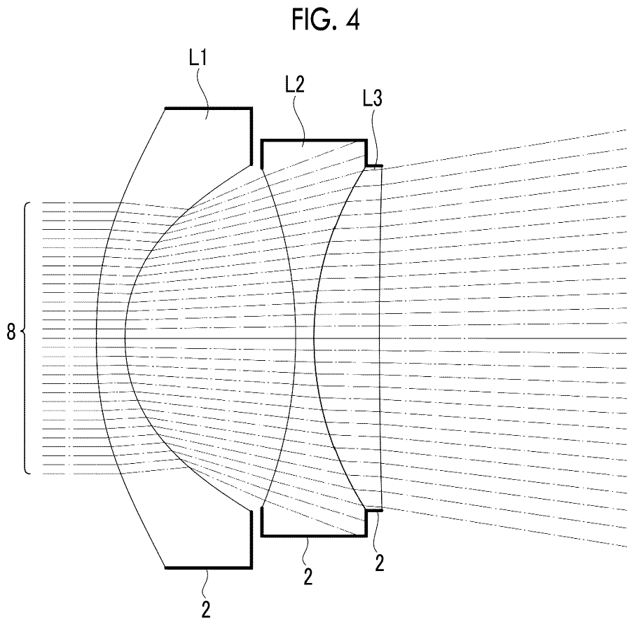

The optical system of FIG. 1 is configured to have a small F-number and have a wide angle. In the optical system having a small F-number and a wide angle, a diameter of the lens closest to the object side is large, and a negative lens having a strong refractive power is often disposed on the object side. In such an optical system, light is strongly diffused by the negative lens having a strong refractive power, and thus the outer peripheral surface of the lens is easily seen. FIG. 4 shows a state in which a luminous flux 8 parallel to the optical axis Z is incident on the optical system of FIG. 1 from the object side and the luminous flux is diffused by the lens L1 and the lens L2. The lens L1 and the lens L2 are negative lenses. FIG. 4 shows the luminous flux 8 as a ray group for easy understanding. The lens L3 is a positive lens. In general, since the negative lens has a larger outer peripheral surface area than the positive lens, the outer peripheral surface of the negative lens is more easily seen than the outer peripheral surface of the positive lens. For these reasons, in a case in which the optical system is observed from the object side, the outer peripheral surface of the lens on the object side is easily seen in the optical system having a small F-number and a wide angle. Therefore, by not allowing the corresponding value of Conditional Expression (1) to be equal to or less than the lower limit, it is possible to suppress a situation in which the outer peripheral surface of the lens on the object side is easily seen in a case in which the optical system is observed from the object side.

In order to obtain more favorable characteristics, it is preferable to set the upper limit of Conditional Expression (1) to any of 9, 8, 7, or 6 instead of 10. In addition, it is preferable to set the lower limit of Conditional Expression (1) to any of 1.2, 1.4, 1.6, or 1.8 instead of 1.

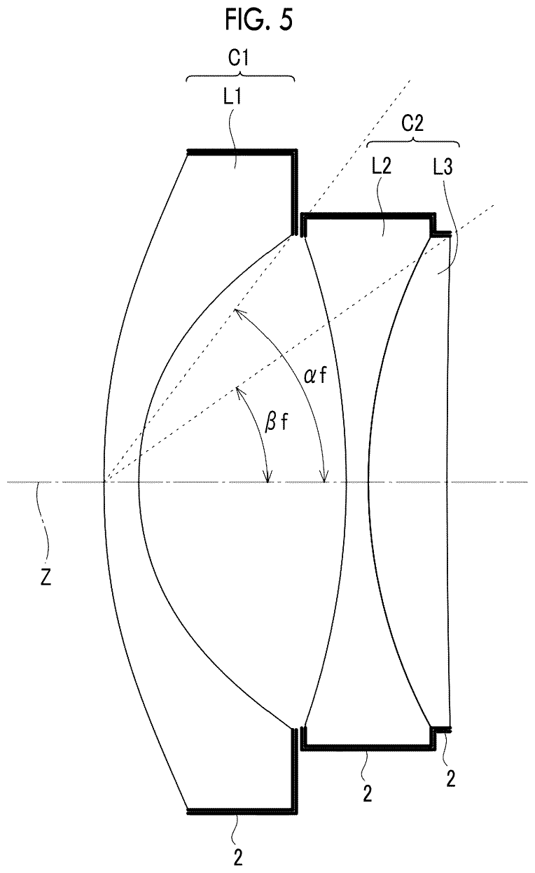

In the optical system according to the present disclosure, it is preferable that the film 2 is provided on 50% or more of a total area of the edge surfaces of all the front lens components satisfying Conditional Expression (2). In the present specification, an intersection between the lens surface of the optical system closest to the object side and the optical axis Z will be referred to as a “front intersection”, and the following symbols are defined for each front lens component. An angle formed between a line connecting the front intersection and a point of the edge surface closest to the object side and the optical axis Z is denoted by αf. An angle formed between a line connecting the front intersection and a point of the edge surface closest to the image side and the optical axis Z is denoted by βf. The units of αf and βf are degrees. For example, FIG. 5 shows the angle αf and the angle βf for the lens component C2 in FIG. 1. In the example of FIG. 5, an intersection between an object side surface of the lens L1 and the optical axis Z corresponds to the front intersection.

$$2.7 ° < α f - β f < 40 ° \qquad ( 2 )$$

Since the lens component satisfying Conditional Expression (2) has a large area of the edge surface, the edge surface is easily seen in a case of being observed from the object side. By providing the film 2 on 50% or more of the total area of the edge surfaces of all the front lens components satisfying Conditional Expression (2), reflection on the edge surfaces of these lens components can be suppressed, and thus it is possible to reduce a situation in which the edge surfaces is visually recognized in a case in which the optical system is observed from the object side. As a result, a high-quality appearance can be maintained.

In order to maintain a higher-quality appearance, it is more preferable that the film 2 is provided on 60% or more of the total area of the edge surfaces of all the front lens components satisfying Conditional Expression (2), it is still more preferable that the film 2 is provided on 65% or more thereof, and it is still more preferable that the film 2 is provided on 75% or more thereof.

In the optical system according to the present disclosure, it is preferable that a proportion of an area on which the film 2 is provided is 30% or less of a total area of the edge surfaces of all the front lens components satisfying Conditional Expressions (3) and (4). Here, N is defined as a natural number of 2 or more, and the angles αf and βf are defined for an N-th front lens component from the object side in the same manner as in a case of Conditional Expression (2). In addition, a composite focal length from the front lens component closest to the object side to the (N−1)th front lens component from the object side is denoted by ff. It should be noted that the above-described “30% or less” includes 0%. That is, the film 2 need not be provided on the entire surface of the edge surfaces of all the front lens components satisfying Conditional Expressions (3) and (4).

$$1.1 ° < α f - β f \leq 2.7 ° \qquad ( 3 )$$

$$- 2.4 < TD / ff \qquad ( 4 )$$

The lens component satisfying Conditional Expression (3) has a relatively large area of the edge surface, but, depending on the shape of the peripheral lens, the focal length, and the like, the outer peripheral surface thereof may not be easily seen even in a case in which the lens component is observed from the object side. By satisfying Conditional Expression (4), the luminous flux that reaches the N-th front lens component from the object side is convergent light or weakly divergent light, so that the outer peripheral surface of the lens component is not easily seen in a case of being observed from the object side. Accordingly, in the optical system in which the proportion of the area on which the film 2 is provided is 30% or less of the total area of the edge surfaces of all the front lens components satisfying Conditional Expressions (3) and (4), the area on which the film 2 is provided on the edge surface of the front lens component is small, but the outer peripheral surface of the lens component is not easily seen in a case of being observed from the object side, so that it is possible to maintain a high-quality appearance. By reducing the area on which the film 2 is provided in the lens component of which the outer peripheral surface is not easily seen, there is an advantage in reducing the cost and the eccentricity as described above.

By reducing the area on which the film 2 is provided, there is an advantage in reducing the cost and reducing the eccentricity, and thus the proportion of the area on which the film 2 is provided in the total area of the edge surfaces of all the front lens components satisfying Conditional Expressions (3) and (4) is more preferably 20% or less, still more preferably 15% or less, and still more preferably 10% or less.

In order to maintain a higher-quality appearance, it is preferable to set the lower limit of Conditional Expression (4) to any of −2.2, −2, −1.8, −1.6, or −1.4 instead of −2.4. In Conditional Expression (4), TD/ff is preferably less than 10, and in such a case, the composite refractive power of all the lens components closer to the object side than the N-th front lens component from the object side is not excessively increased, so that there is an advantage in correcting aberrations.

In addition, in the optical system according to the present disclosure, it is preferable that a proportion of an area on which the film 2 is provided is 30% or less of a total area of the edge surfaces of all the front lens components satisfying Conditional Expressions (3) and (5). Here, N is defined as a natural number of 2 or more, and the angles αf and βf are defined for an N-th front lens component from the object side in the same manner as described above. In addition, a paraxial curvature radius of a surface, which is closest to the image side, of the N-th front lens component from the object side is denoted by Rf. It should be noted that the above-described “30% or less” includes 0%. That is, the film 2 need not be provided on the entire surface of the edge surfaces of all the front lens components satisfying Conditional Expressions (3) and (5).

$$1.1 ° < α f - β f \leq 2.7 ° \qquad ( 3 )$$

$$TD / Rf < 2.4 \qquad ( 5 )$$

As described above, the outer peripheral surface of the lens component satisfying Conditional Expression (3) may not be easily seen even in a case in which the lens component is observed from the object side. By satisfying Conditional Expression (5), the surface, which is closest to the image side, of the N-th front lens component from the object side is a convex surface or a concave surface having a relatively large curvature radius, and thus the outer peripheral surface of the lens component is not easily seen in a case of being observed from the object side. Accordingly, in the optical system in which the proportion of the area on which the film 2 is provided is 30% or less of the total area of the edge surfaces of all the front lens components satisfying Conditional Expressions (3) and (5), the area on which the film 2 is provided on the edge surface of the front lens component is small, but the outer peripheral surface of the lens component is not easily seen in a case of being observed from the object side, so that it is possible to maintain a high-quality appearance. By reducing the area on which the film 2 is provided in the lens component of which the outer peripheral surface is not easily seen, there is an advantage in reducing the cost and the eccentricity as described above.

By reducing the area on which the film 2 is provided, there is an advantage in reducing the cost and reducing the eccentricity, and thus the proportion of the area on which the film 2 is provided in the total area of the edge surfaces of all the front lens components satisfying Conditional Expressions (3) and (5) is more preferably 20% or less, still more preferably 15% or less, and still more preferably 10% or less.

In order to maintain a higher-quality appearance, it is preferable to set the upper limit of Conditional Expression (5) to any of 2.2, 2, 1.8, 1.6, 1.4, 1.2, 1, 0.8, or 0.77 instead of 2.4. In Conditional Expression (5), TD/Rf is preferably more than −10, and in such a case, an absolute value of the curvature radius of the surface, which is closest to the image side, of the N-th front lens component from the object side is not excessively decreased, and thus good workability can be maintained, and the refractive power of the surface is not excessively increased, so that there is an advantage in correcting aberrations.

In the optical system according to the present disclosure, it is preferable that a proportion of an area on which the film 2 is provided is 30% or less of a total area of the edge surfaces of all the front lens components satisfying Conditional Expression (10). Here, the angles αf and βf are defined for each front lens component in the same manner as described above. It should be noted that the above-described “30% or less” includes 0%. That is, the film 2 need not be provided on the entire surface of the edge surfaces of all the front lens components satisfying Conditional Expression (10).

$$0 ° < α f - β f \leq 1.1 ° \qquad ( 10 )$$

Since the lens component satisfying Conditional Expression (10) has a short length (edge thickness) of the edge surface in the optical axis direction and a small area of the edge surface, the outer peripheral surface is not easily seen even in a case in which the lens is observed from the object side. Accordingly, in the optical system in which the proportion of the area on which the film 2 is provided is 30% or less of the total area of the edge surfaces of all the front lens components satisfying Conditional Expression (10), the area on which the film 2 is provided on the edge surface of the front lens component is small, but the outer peripheral surface of the lens component is not easily seen in a case of being observed from the object side, so that it is possible to maintain a high-quality appearance. By reducing the area on which the film 2 is provided in the lens component of which the outer peripheral surface is not easily seen, there is an advantage in reducing the cost and the eccentricity as described above.

By reducing the area on which the film 2 is provided, there is an advantage in reducing the cost and reducing the eccentricity, and thus the proportion of the area on which the film 2 is provided in the total area of the edge surfaces of all the front lens components satisfying Conditional Expression (10) is more preferably 20% or less, still more preferably 15% or less, and still more preferably 10% or less.

Next, a case will be described in which the optical system is observed from the image side. Even in a case in which the optical system is observed from the image side, the same can be considered as in a case in which the optical system is observed from the object side. In a case in which the optical system is observed from the image side, the edge surface of the lens closer to the image side is almost visually recognized. In addition, a range of 0.3×TD from the lens surface of the optical system closest to the image side to the object side on the optical axis is a range that is easily visually recognized in a case in which the optical system is observed from the image side.

For convenience of description, a range from the lens surface of the optical system closest to the image side to the object side to 0.3×TD will be referred to as a “rear visual recognition range”. In the example of FIG. 1, among two ranges indicated by “0.3×TD”, a range indicated by “0.3×TD” on the image side corresponds to the rear visual recognition range.

Among the lens components included in the optical system, a lens component in which at least a part of the lens component is located in the rear visual recognition range on the optical axis will be referred to as a “rear lens component”. That is, among the lens components included in the optical system, a lens component in which a surface of the lens component closest to the image side is located in the rear visual recognition range on the optical axis will be referred to as the “rear lens component”. In the example of FIG. 1, the lens component C6, the lens component C7, the lens component C8, and the lens component C9 each correspond to the rear lens component.

In the technology of the present disclosure, the film 2 is provided on 50% or more of a total area of the edge surfaces of all the rear lens components. With this configuration, it is possible to reduce a situation in which the edge surface is visually recognized in a case in which the optical system is observed from the image side, and thus it is possible to maintain a high-quality appearance. In addition, by providing the film 2 on the edge surface, it is possible to suppress ghosts and flares caused by reflection inside the optical system, which can contribute to maintaining favorable performance.

In order to maintain a higher-quality appearance, it is more preferable that the film 2 is provided on 60% or more of the total area of the edge surfaces of all the rear lens components, it is still more preferable that the film 2 is provided on 65% or more thereof, and it is still more preferable that the film 2 is provided on 75% or more thereof.

In the example of FIG. 1, the total area of the edge surfaces of the rear lens components is a sum of the areas of the edge surfaces of all the lenses L8 to L13. In the example of FIG. 1, since the film 2 is provided on the entire surface of the edge surfaces of the lenses L8 to L13, the film 2 is provided on 100% of the total area of the edge surface of the rear lens component.

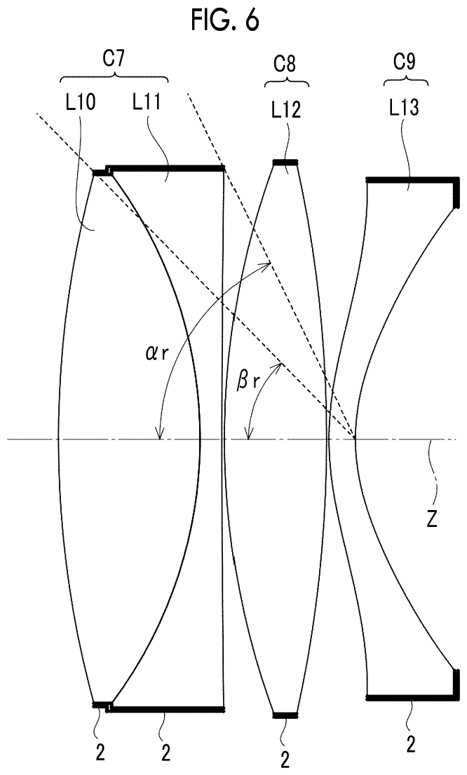

In the optical system according to the present disclosure, it is preferable that the film 2 is provided on 50% or more of a total area of the edge surfaces of all the rear lens components satisfying Conditional Expression (6). In the present specification, an intersection between the lens surface of the optical system closest to the image side and the optical axis Z will be referred to as a “rear intersection”, and the following symbols are defined for each rear lens component. An angle formed between a line connecting the rear intersection and a point of the edge surface closest to the image side and the optical axis Z is denoted by αr. An angle formed between a line connecting the rear intersection and a point of the edge surface closest to the object side and the optical axis Z is denoted by βr. The units of αr and βr are degrees. For example, FIG. 6 shows the angle αr and the angle βr for the lens component C7 in FIG. 1. In the example of FIG. 6, an intersection between an image side surface of the lens L13 and the optical axis Z corresponds to the rear intersection.

$$2.7 ° < α r - β r < 40 ° \qquad ( 6 )$$

Since the lens component satisfying Conditional Expression (6) has a large area of the edge surface, the edge surface is easily seen in a case of being observed from the image side. By providing the film 2 on 50% or more of the total area of the edge surfaces of all the rear lens components satisfying Conditional Expression (6), reflection on the edge surfaces of these lens components can be suppressed, and thus it is possible to reduce a situation in which the edge surfaces is visually recognized in a case in which the optical system is observed from the image side. As a result, a high-quality appearance can be maintained.

In order to maintain a higher-quality appearance, it is more preferable that the film 2 is provided on 60% or more of the total area of the edge surfaces of all the rear lens components satisfying Conditional Expression (6), it is still more preferable that the film 2 is provided on 65% or more thereof, and it is still more preferable that the film 2 is provided on 75% or more thereof.

In the optical system according to the present disclosure, it is preferable that a proportion of an area on which the film 2 is provided is 30% or less of a total area of the edge surfaces of all the rear lens components satisfying Conditional Expressions (7) and (8). Here, Mis defined as a natural number of 2 or more, and the angles αr and βr are defined for an M-th rear lens component from the object side in the same manner as in a case of Conditional Expression (6). In addition, a composite focal length from the rear lens component closest to the image side to the (M−1)th rear lens component from the image side is denoted by fr. It should be noted that the above-described “30% or less” includes 0%. That is, the film 2 need not be provided on the entire surface of the edge surfaces of all the rear lens components satisfying Conditional Expressions (7) and (8).

$$1.1 ° < α r - β r \leq 2.7 ° \qquad ( 7 )$$

$$- 2.4 < TD / fr \qquad ( 8 )$$

The lens component satisfying Conditional Expression (7) has a relatively large area of the edge surface, but, depending on the shape of the peripheral lens, the focal length, and the like, the outer peripheral surface thereof may not be easily seen even in a case in which the lens component is observed from the image side. By satisfying Conditional Expression (8), the luminous flux that reaches the M-th rear lens component from the image side is convergent light or weakly divergent light, so that the outer peripheral surface of the lens component is not easily seen in a case of being observed from the image side. Accordingly, in the optical system in which the proportion of the area on which the film 2 is provided is 30% or less of the total area of the edge surfaces of all the rear lens components satisfying Conditional Expressions (7) and (8), the area on which the film 2 is provided on the edge surface of the rear lens component is small, but the outer peripheral surface of the lens component is not easily seen in a case of being observed from the image side, so that it is possible to maintain a high-quality appearance. By reducing the area on which the film 2 is provided in the lens component of which the outer peripheral surface is not easily seen, there is an advantage in reducing the cost and the eccentricity as described above.

By reducing the area on which the film 2 is provided, there is an advantage in reducing the cost and reducing the eccentricity, and thus the proportion of the area on which the film 2 is provided in the total area of the edge surfaces of all the rear lens components satisfying Conditional Expressions (7) and (8) is more preferably 20% or less, still more preferably 15% or less, and still more preferably 10% or less.

In order to maintain a higher-quality appearance, it is preferable to set the lower limit of Conditional Expression (8) to any of −2.2, −2, −1.8, −1.7, or −1.6 instead of −2.4. In Conditional Expression (8), TD/fr is preferably less than 10, and in such a case, the composite refractive power of all the lens components closer to the image side than the M-th rear lens component from the image side is not excessively increased, so that there is an advantage in correcting aberrations.

In addition, in the optical system according to the present disclosure, it is preferable that a proportion of an area on which the film 2 is provided is 30% or less of a total area of the edge surfaces of all the rear lens components satisfying Conditional Expressions (7) and (9). Here, M is defined as a natural number of 2 or more, and the angle αr and the angle βr are defined for an M-th rear lens component from the image side in the same manner as described above. In addition, a paraxial curvature radius of a surface, which is closest to the object side, of the M-th rear lens component from the image side is denoted by Rr. It should be noted that the above-described “30% or less” includes 0%. That is, the film 2 need not be provided on the entire surface of the edge surfaces of all the rear lens components satisfying Conditional Expressions (7) and (9).

$$1.1 ° < α r - β r \leq 2.7 ° \qquad ( 7 )$$

$$- 10 < TD / Rr \qquad ( 9 )$$

As described above, the outer peripheral surface of the lens component satisfying Conditional Expression (7) may not be easily seen even in a case in which the lens component is observed from the image side. By satisfying Conditional Expression (9), the surface, which is closest to the object side, of the M-th rear lens component from the image side is a convex surface or a concave surface having a relatively large absolute value of the curvature radius, and thus the outer peripheral surface of the lens component is not easily seen in a case of being observed from the image side. Accordingly, in the optical system in which the proportion of the area on which the film 2 is provided is 30% or less of the total area of the edge surfaces of all the rear lens components satisfying Conditional Expressions (7) and (9), the area on which the film 2 is provided on the edge surface of the rear lens component is small, but the outer peripheral surface of the lens component is not easily seen in a case of being observed from the image side, so that it is possible to maintain a high-quality appearance. By reducing the area on which the film 2 is provided in the lens component of which the outer peripheral surface is not easily seen, there is an advantage in reducing the cost and the eccentricity as described above.

By reducing the area on which the film 2 is provided, there is an advantage in reducing the cost and reducing the eccentricity, and thus the proportion of the area on which the film 2 is provided in the total area of the edge surfaces of all the rear lens components satisfying Conditional Expressions (7) and (9) is preferably 20% or less, more preferably 15% or less, and still more preferably 10% or less.

In order to maintain a higher-quality appearance, it is preferable to set the lower limit of Conditional Expression (9) to any of −9, −8, −7, −6, −5, −4, −3, −2, or −1.1 instead of −10. In Conditional Expression (9), TD/Rr is preferably less than 10, and in such a case, the curvature radius of the surface, which is closest to the object side, of the M-th rear lens component from the image side is not excessively decreased, and thus good workability can be maintained, and the refractive power of the surface is not excessively increased, so that there is an advantage in correcting aberrations.

In the optical system according to the present disclosure, it is preferable that a proportion of an area on which the film 2 is provided is 30% or less of a total area of the edge surfaces of all the rear lens components satisfying Conditional Expression (11). Here, the angle αr and the angle βr are defined for each of the rear lens components in the same manner as described above. It should be noted that the above-described “30% or less” includes 0%. That is, the film 2 need not be provided on the entire surface of the edge surfaces of all the rear lens components satisfying Conditional Expression (11).

$$0 ° < α r - β r \leq 1.1 ° \qquad ( 11 )$$

Since the lens component satisfying Conditional Expression (11) has a short length (edge thickness) of the edge surface in the optical axis direction and a small area of the edge surface, the outer peripheral surface is not easily seen even in a case in which the lens is observed from the image side. Accordingly, in the optical system in which the proportion of the area on which the film 2 is provided is 30% or less of the total area of the edge surfaces of all the rear lens components satisfying Conditional Expression (11), the area on which the film 2 is provided on the edge surface of the rear lens component is small, but the outer peripheral surface of the lens component is not easily seen in a case of being observed from the image side, so that it is possible to maintain a high-quality appearance. By reducing the area on which the film 2 is provided in the lens component of which the outer peripheral surface is not easily seen, there is an advantage in reducing the cost and the eccentricity as described above.

By reducing the area on which the film 2 is provided, there is an advantage in reducing the cost and reducing the eccentricity, and thus the proportion of the area on which the film 2 is provided in the total area of the edge surfaces of all the rear lens components satisfying Conditional Expression (11) is more preferably 20% or less, still more preferably 15% or less, and still more preferably 10% or less.

In consideration of both the object side and the image side, in the optical system according to the present disclosure, the proportion of the area on which the film 2 is provided in the total area of the edge surfaces of all the front lens components satisfying Conditional Expression (10) and the edge surfaces of all the rear lens components satisfying Conditional Expression (11) is preferably 30% or less. It should be noted that the above-described “30% or less” includes 0%. That is, the film 2 need not be provided on the entire surface of the edge surfaces of all the front lens components satisfying Conditional Expression (10) and the entire surface of the edge surfaces of all the rear lens components satisfying Conditional Expression (11).

By reducing the area on which the film 2 is provided, there is an advantage in achieving cost reduction and reduction of eccentricity, so that the proportion of the area on which the film 2 is provided in the total area of the edge surfaces of all the front lens components satisfying Conditional Expression (10) and the edge surfaces of all the rear lens components satisfying Conditional Expression (11) is more preferably 20% or less, still more preferably 15% or less, and still more preferably 10% or less.

The example shown in FIG. 1 is merely an example, and various modifications can be made without departing from the gist of the technology of the present disclosure. The technology of the present disclosure may be applied only to the front lens component, the technology of the present disclosure may be applied only to the rear lens component, or the technology of the present disclosure may be applied to the front lens component and the rear lens component. In addition, the optical system according to the present disclosure may be a fixed focal point optical system or a variable magnification optical system.

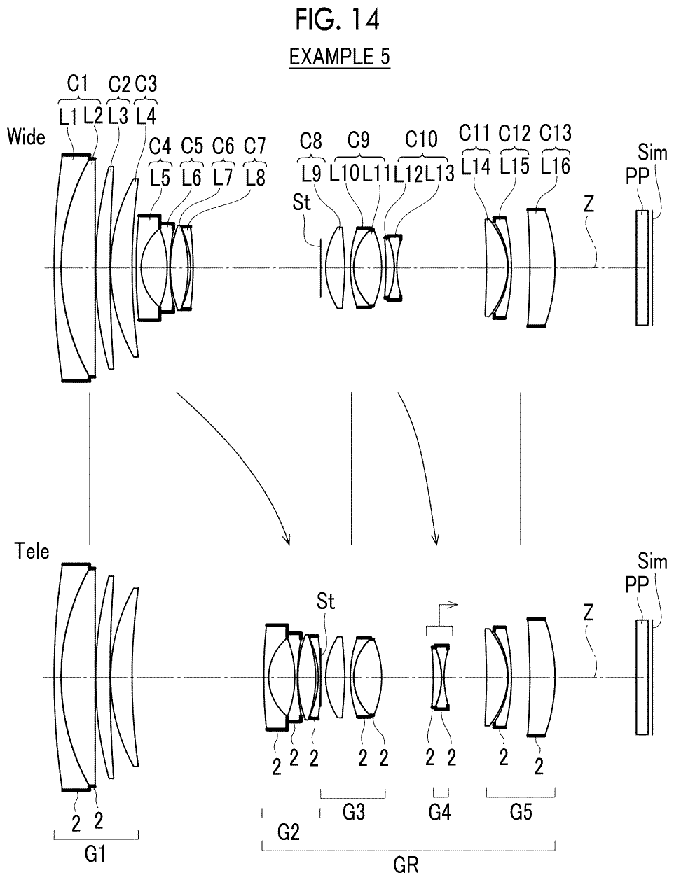

FIG. 14 shows an example of the variable magnification optical system according to the present disclosure. The example shown in FIG. 14 corresponds to Example 5 described below. As shown in FIG. 14, the variable magnification optical system according to the present disclosure may comprise, in order from the object side to the image side, a first lens group G1 having a positive refractive power and a subsequent group GR including at least one lens group, in which a spacing between adjacent lens groups changes during changing magnification. With this configuration, it is possible to suppress fluctuation in aberration during changing magnification from a wide angle end to a telephoto end.

The subsequent group GR of the variable magnification optical system may include a second lens group G2 having a negative refractive power, at a position closest to the object side. With this configuration, it is possible to suppress fluctuation in aberration during changing magnification from the wide angle end to the telephoto end. More specifically, the subsequent group GR may include, in successive order from the object side to the image side, the second lens group G2, a third lens group G3, and a fourth lens group G4, and at least the second lens group G2 and the fourth lens group G4 may move during changing magnification. In such a case, there is an advantage in achieving an optical system having a high magnification change ratio and having small fluctuation in aberrations during changing magnification. Further, the subsequent group GR may include a focusing group that is a group moving along the optical axis Z during focusing. In such a case, since it is easy to reduce the effective diameter of the focusing group, it is easy to reduce the weight of the focusing group, so that there is an advantage in performing the focusing operation quickly and with high accuracy.

In the technology of the present disclosure, the optical system according to the present disclosure may be a variable magnification optical system having a configuration different from the example shown in FIG. 14. In a case in which the optical system is a variable magnification optical system, the optical system need only have the configuration of the technology of the present disclosure at least at one of the wide angle end or the telephoto end. This is because, in a case in which a user observes the appearance of the lens of the optical system, the user often observes the appearance of the lens in a wide angle end state or a telephoto end state.

In addition, in a system in which a part of the optical system is configured to move during focusing, the value of the above-described conditional expression is a value in a state in which the infinite distance object is in focus.

The above-described preferable configurations and available configurations can be combined with each other in any manner, and it is preferable that the above-described preferable configurations and available configurations are employed as appropriate selectively in accordance with required specifications.

For example, a preferred aspect of the optical system according to the present disclosure is an optical system comprising: at least one lens component in a case in which one lens component is one single lens or one cemented lens, in which in a case in which an outer peripheral surface of the lens component parallel to an optical axis Z is defined as an edge surface, a distance, on the optical axis, from a lens surface of the optical system closest to an object side to a lens surface of the optical system closest to an image side is denoted by TD, and the lens component, in which at least a part of the lens component is located in a range of 0.3×TD from the lens surface of the optical system closest to the object side to the image side on the optical axis Z, among the lens components included in the optical system is defined as a front lens component, a film 2 having a light reflectivity of less than 30% is provided on 50% or more of a total area of the edge surfaces of all the front lens components. The reflectivity of the film 2 is preferably less than 25%, more preferably less than 20%, still more preferably less than 15%, and still more preferably less than 10%.

Another preferred aspect of the optical system according to the present disclosure is an optical system comprising: at least one lens component in a case in which one lens component is one single lens or one cemented lens, in which in a case in which an outer peripheral surface of the lens component parallel to an optical axis Z is defined as an edge surface, a distance, on the optical axis, from a lens surface of the optical system closest to an object side to a lens surface of the optical system closest to an image side is denoted by TD, and the lens component, in which at least a part of the lens component is located in a range of 0.3×TD from the lens surface of the optical system closest to the image side to the object side on the optical axis Z, among the lens components included in the optical system is defined as a rear lens component, a film 2 having a light reflectivity of less than 30% is provided on 50% or more of a total area of the edge surfaces of all the rear lens components. The reflectivity of the film 2 is preferably less than 25%, more preferably less than 20%, still more preferably less than 15%, and still more preferably less than 10%.

Next, examples of the optical system according to the present disclosure will be described with reference to the accompanying drawings. It should be noted that reference numerals provided to the lenses and the lens components in the cross-sectional view of each example are independently used for each example in order to avoid complication of description and the drawings caused by an increasing number of digits of the reference numerals. Therefore, even in a case in which a common reference numeral is provided in the drawings of different examples, the common reference numeral does not necessarily indicate a common configuration.

### Example 1

Since a cross-sectional view of the configuration of the optical system according to Example 1 is shown in FIG. 1, and its showing method and configuration are the same as described above, the duplicate descriptions will be partially omitted. The optical system according to Example 1 comprises, in order from the object side to the image side, lens components C1 to C5, an aperture stop St, and lens components C6 to C9. The lens components C1 and C2 each correspond to the front lens component, and the lens components C6 to C9 each correspond to the rear lens component. The film 2 is provided on the edge surfaces of the lens components C1 to C4 and C6 to C9. The focusing group is composed of the lens components C6 to C9. During focusing on a short range object from the infinite distance object, the lens components forming the focusing group integrally move to the object side. It should be noted that, in the present specification, “integrally move” means moving by the same amount in the same direction at the same time.

For the optical system according to Example 1, Table 1 shows basic lens data, Table 2 shows specifications, and Table 3 shows aspherical coefficients.

The table of the basic lens data is described as follows. The column of “Sn” indicates surface numbers in a case in which the number is increased by one at a time toward the image side from a surface closest to the object side as a first surface. The column of “R” indicates a curvature radius of each surface. The column of “D” indicates a surface spacing on the optical axis between each surface and its adjacent surface on the image side. The column of “Nd” indicates a refractive index of each constituent element at the d line. The column of “vd” indicates an Abbe number of each constituent element based on the d line. The column of “outer diameter” indicates an outer diameter of each constituent element, that is, the lens outer diameter. In the column of “Film”, “presence” is written in the field of the constituent element in which the film 2 is provided on the edge surface, and “absence” is written in the field of the constituent element in which the film 2 is not provided on the edge surface. In the field of “α−β”, the value of αf−βf is shown for the front lens component, and the value of αr−βr is shown for the rear lens component. The leftmost column of the surface corresponding to the front lens component is denoted by “fC”, and the leftmost column of the surface corresponding to the rear lens component is denoted by “rC”.

In the table of the basic lens data, a sign of a curvature radius of a surface having a convex shape facing the object side is defined as positive, and a sign of a curvature radius of a surface having a convex shape facing the image side is defined as negative. The surface number and the term (St) are written in the field of the surface number of the surface corresponding to the aperture stop St. The table of basic lens data also shows the optical member PP. A value in the lowermost field of the column of the surface spacing in the table indicates a spacing between the surface closest to the image side in the table and the image plane Sim.

Table 2 shows a focal length f, a back focus βf at an air conversion distance, an open F-number FNo., a maximum full angle of view 20, an open stop diameter Stφ, a total length TL of the optical system, and a lens length TD, based on the d line. FNo. in Table 2 has the same meaning as FNo in Conditional Expression (1). In the field of the maximum full angle of view, [°] indicates that the unit is degrees. TL is a sum of the lens length TD and the back focus βf at the air conversion distance. Stφ is an aperture diameter of the aperture stop St in a case in which the aperture stop St is in an open state. Table 2 shows values in a state in which the infinite distance object is in focus.

In the table of the basic lens data, the surface number of the aspherical surface is marked with *, and the field of the curvature radius of the aspherical surface shows a numerical value of the paraxial curvature radius. In Table 3, the line of Sn shows the surface number of the aspherical surface, and the lines of KA and Am show a numerical value of the aspherical coefficient for each aspherical surface. It should be noted that m of Am is an integer equal to or more than 3, and varies depending on the surface. For example, in the first surface according to Example 1, m=3, 4, 5, . . . , and 16. In Table 3, “E±n” (n: integer) of the numerical value of the aspherical coefficient means “×10^{±n}”. KA and Am are aspherical coefficients in an aspheric equation represented by the following equation.

$$Zd = C \times {h}^{2} / \{ 1 + {( 1 - KA \times {C}^{2} \times {h}^{2} )}^{1 / 2} \} + \sum Am \times {h}^{m}$$

Here,
Zd: aspherical surface depth (a length of a perpendicular line drawn from a point on the aspheric surface at height h to a plane perpendicular to the optical axis Z where the apex of the aspheric surface is in contact),
h: height (distance from optical axis Z to lens surface),
C: reciprocal of paraxial curvature radius, and
KA, Am: aspherical coefficients,
and Σ means the sum with respect to m in aspherical surface equation.

In the data of each table, degrees are used as a unit of angles, and a millimeter (mm) is used for a unit of lengths, but, since the optical system can also be proportionally enlarged or proportionally reduced to be used, other appropriate units can also be used. Further, numerical values rounded to predetermined digits are described in each table shown below.

TABLE 1
Example 1

| | | | | | | Outer | | |
|---|---|---|---|---|---|---|---|---|
| | Sn | R | D | Nd | νd | diameter | Film | α − β |
| fC | *1 | 50.9202 | 1.8721 | 1.58313 | 59.38 | 36.00 | Presence | 15.23 |
| | *2 | 15.5929 | 11.1254 | | | | | |
| | 3 | −41.2861 | 1.1918 | 1.48749 | 70.44 | 29.00 | Presence | 17.33 |
| | 4 | 28.6638 | 4.2247 | 2.00069 | 25.46 | 27.00 | Presence | |
| | 5 | 547.2491 | 5.8234 | | | | | |
| | 6 | −45.3239 | 2.1805 | 1.68893 | 31.07 | 25.00 | Presence | |
| | 7 | 68.3842 | 4.6317 | 1.69680 | 55.53 | 23.50 | Presence | |
| | 8 | −26.2063 | 1.1493 | | | | | |
| | 9 | −18.8555 | 0.9231 | 1.74077 | 27.79 | 24.00 | Presence | |
| | 10 | −317.6806 | 0.1000 | | | | | |
| | 11 | 83.7496 | 4.1391 | 1.95375 | 32.32 | 25.50 | Absence | |
| | 12 | −37.6767 | 3.5285 | | | | | |
| | 13(St) | ∞ | 6.8400 | | | | | |
| rC | 14 | 26.4192 | 8.7875 | 1.55032 | 75.50 | 24.00 | Presence | 13.46 |
| | 15 | −20.4793 | 0.8968 | 1.78880 | 28.43 | 24.00 | Presence | |
| | 16 | 94.9622 | 0.1000 | | | | | |
| | 17 | 43.8350 | 5.9348 | 1.75500 | 52.32 | 22.60 | Presence | 18.51 |
| | 18 | −19.0896 | 0.9112 | 1.85478 | 24.80 | 23.00 | Presence | |
| | 19 | 873.6132 | 0.1001 | | | | | |
| | 20 | 34.7161 | 4.2520 | 1.92286 | 18.90 | 23.50 | Presence | 4.36 |
| | 21 | −55.7621 | 0.1000 | | | | | |
| | *22 | 12.8449 | 1.1053 | 1.80625 | 40.91 | 22.00 | Presence | 18.14 |
| | *23 | 8.6197 | 16.5117 | | | | | |
| | 24 | ∞ | 2.8500 | 1.51680 | 64.20 | | | |
| | 25 | ∞ | 1.1000 | | | | | |

TABLE 2
Example 1

| | |
|---|---|
| f | 18.20 |
| Bf | 19.49 |
| FNo. | 1.44 |
| 2ω[°] | 76.4 |
| Stφ | 23.07 |
| TL | 89.41 |
| TD | 69.92 |

TABLE 3
Example 1

| Sn | 1 | 2 | 22 | 23 |
|---|---|---|---|---|
| KA | −3.5524107E+00 | −4.3839153E−01 | −8.7749470E−01 | −1.7564944E+00 |
| A3 | 0.0000000E+00 | 0.0000000E+00 | 0.0000000E+00 | 0.0000000E+00 |
| A4 | 1.4562563E−04 | 1.9987653E−04 | −2.9457203E−04 | 4.5987345E−05 |
| A5 | −1.5586134E−05 | −1.4237156E−05 | −3.0213717E−05 | −4.2734089E−05 |
| A6 | 5.2002049E−07 | 3.8653493E−08 | 8.8294930E−06 | 8.3923312E−06 |
| A7 | 4.4576460E−08 | 9.7639392E−08 | −6.3236083E−07 | −6.7249893E−07 |
| A8 | −7.2822532E−09 | 1.3127811E−10 | 6.6065017E−08 | 3.8700650E−08 |
| A9 | 2.3897513E−10 | −1.7402613E−09 | −1.8681912E−08 | −1.0369127E−09 |
| A10 | 2.0729060E−11 | 1.0104915E−10 | 2.8496418E−09 | −7.1101541E−10 |
| A11 | −4.2346876E−13 | 1.0980116E−11 | −2.1192026E−10 | 1.4318222E−10 |
| A12 | −2.6304469E−13 | −1.4408297E−12 | 5.7452181E−12 | −4.3454846E−12 |
| A13 | 2.7068251E−14 | 5.0098114E−14 | 1.3592773E−13 | −1.7638060E−12 |
| A14 | −1.2272789E−15 | 2.0411475E−16 | −3.2656663E−15 | 2.5353158E−13 |
| A15 | 2.8191990E−17 | −5.1685374E−17 | −6.9338244E−16 | −1.4072532E−14 |
| A16 | −2.6907030E−19 | 9.6690889E−19 | 2.5709964E−17 | 2.9452493E−16 |

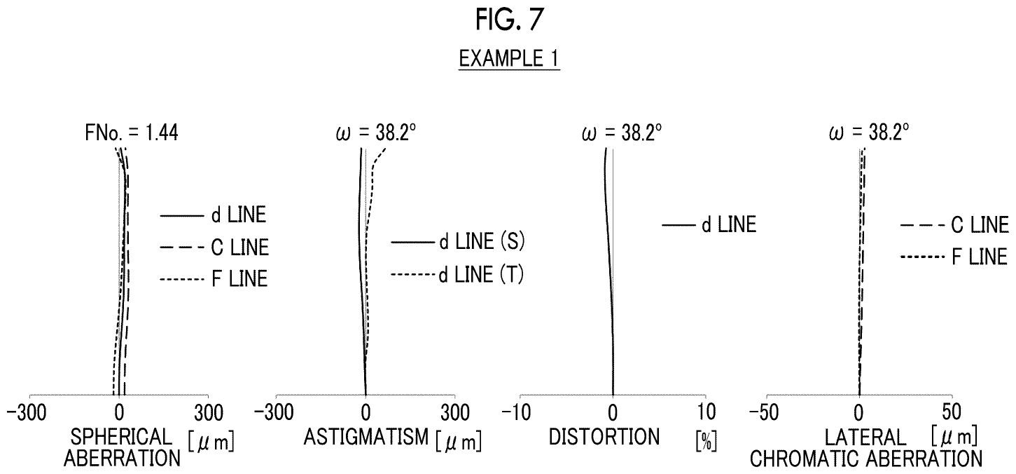

FIG. 7 shows each aberration diagram of the optical system of Example 1 in a state in which the infinite distance object is in focus. In FIG. 7, the spherical aberration, the astigmatism, the distortion, and the lateral chromatic aberration are shown in order from the left. In the spherical aberration diagram, the aberrations on the d line, the C line, and the F line are shown by a solid line, a long broken line, and a short broken line, respectively. In the astigmatism diagram, the aberration on the d line in a sagittal direction is shown by a solid line, and the aberration on the d line in a tangential direction is shown by a short broken line. In the distortion diagram, the aberration on the d line is shown by a solid line. In the lateral chromatic aberration diagram, the aberrations on the C line and the F line are shown by a long broken line and a short broken line, respectively. In the spherical aberration diagram, a value of the open F-number is shown after “FNo.=”. In other aberration diagrams, a value of the maximum half angle of view is shown after “ω=”.

Table 4 shows the presence or absence of the film 2 on the edge surface in each lens component of the front lens component, and the corresponding values of Conditional Expressions (1) to (5) and (10). Table 5 shows the presence or absence of the film 2 on the edge surface of each lens component of the rear lens component, and the corresponding values of Conditional Expressions (6) to (9) and (11). In Tables 4 and 5, the number in parentheses before the conditional expression indicates the number of the conditional expression, and the respective lens component is indicated by using the corresponding reference numeral. For example, “C1” in Table 4 indicates the lens component C1, and the column of “C1” shows values and information related to the lens component C1. However, for the lens component that does not satisfy Conditional Expression (3), the corresponding values of Conditional Expressions (4) and (5) are not described, and for the lens component that does not satisfy Conditional Expression (7), the corresponding values of Conditional Expressions (8) and (9) are not described.

In addition, Tables 4 and 5 show values of the following proportions A to I. All the proportions A to I are shown as percentages. In a case in which there is no corresponding lens component, “No corresponding lens component” is written.
Proportion A: a proportion of the area on which the film 2 is provided in the total area of the edge surfaces of the front lens components
Proportion B: a proportion of the area on which the film 2 is provided in the total area of the edge surfaces of all the front lens components satisfying Conditional Expression (2)
Proportion C: a proportion of the area on which the film 2 is provided in the total area of the edge surfaces of all the front lens components satisfying Conditional Expressions (3) and (4)
Proportion D: a proportion of the area on which the film 2 is provided in the total area of the edge surfaces of all the front lens components satisfying Conditional Expressions (3) and (5)
Proportion E: a proportion of the area on which the film 2 is provided in the total area of the edge surfaces of the rear lens component
Proportion F: a proportion of the area on which the film 2 is provided in the total area of the edge surfaces of all the rear lens components satisfying Conditional Expression (6)
Proportion G: a proportion of the area on which the film 2 is provided in the total area of the edge surfaces of all the rear lens components satisfying Conditional Expressions (7) and (8)
Proportion H: a proportion of the area on which the film 2 is provided in the total area of the edge surfaces of all the rear lens components satisfying Conditional Expressions (7) and (9)
Proportion I: a proportion of the area on which the film 2 is provided in the total area of the edge surfaces of all the front lens components satisfying Conditional Expression (10) and the edge surfaces of all the rear lens components satisfying Conditional Expression (11)

TABLE 4
Example 1
(l) FNo/tanω = 1.830

Front lens
component

| | C1 | C2 |
|---|---|---|
| Presence or absence of | Presence | Presence |
| film of edge surface | | |

| | |
|---|---|
| Proportion A | 100% |

| | | |
|---|---|---|
| (2) 2.7° < αf − βf < 40° | 15.23° | 17.33° |

| | |
|---|---|
| Proportion B | 100% |

| | | |
|---|---|---|
| (3) 1.1° < αf − βf ≤ 2.7° | 15.23° | 17.33° |
| (4) −2.4 < TD/ff | — | — |

| | |
|---|---|
| Proportion C | No corresponding |
| | lens component |

| | | |
|---|---|---|
| (3) 1.1° < αf − βf ≤ 2.7° | 15.23° | 17.33° |
| (5) TD/Rf < 2.4 | — | — |

| | |
|---|---|
| Proportion D | No corresponding |
| | lens component |

| | | |
|---|---|---|
| (10) 0° < αf − βf ≤ 1.1° | 15.23° | 17.33° |

TABLE 5
Example 1

| | Rear lens component | | | |
|---|---|---|---|---|
| | C6 | C7 | C8 | C9 |
| Presence or absence of film | Presence | Presence | Presence | Presence |
| of edge surface | | | | |
| Proportion E | 100% | | | |
| (6) 2.7° < αr − βr < 40° | 13.46° | 18.51° | 4.36° | 18.14° |
| Proportion F | 100% | | | |
| (7) 1.1° < αr − βr ≤ 2.7° | 13.46° | 18.51° | 4.36° | 18.14° |
| (8) −2.4 < TD/fr | — | — | — | — |
| Proportion G | No corresponding lens component | | | |
| (7) 1.1° < αr − βr ≤ 2.7° | 13.46° | 18.51° | 4.36° | 18.14° |
| (9) −10 < TD/Rr | — | — | — | — |
| Proportion H | No corresponding lens component | | | |
| (11) 0° < αr − βr ≤ 1.1° | 13.46° | 18.51° | 4.36° | 18.14° |

| | |
|---|---|
| Proportion I | No corresponding lens component |

Symbols, meanings, description methods, and showing methods of each data related to Example 1 are basically the same in the following examples unless otherwise noted, and thus the duplicate description will be omitted below.

### Example 2

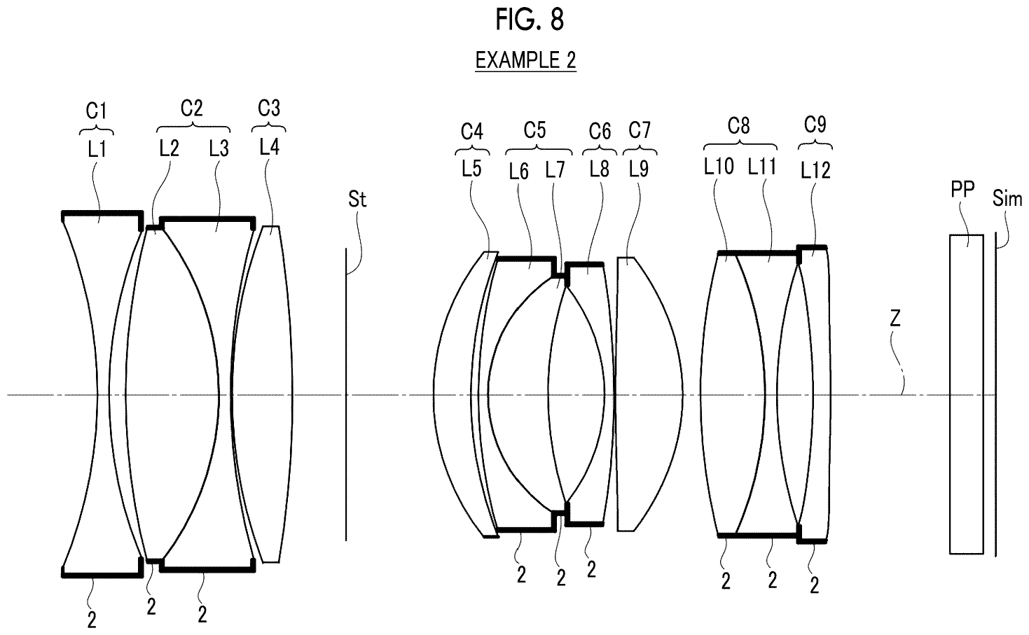

A cross-sectional view of a configuration of an optical system according to Example 2 is shown in FIG. 8. The optical system according to Example 2 comprises, in order from the object side to the image side, lens components C1 to C3, an aperture stop St, and lens components C4 to C9. The lens component C1 is composed of a lens L1 that is a single lens. The lens component C2 is composed of a cemented lens in which a lens L2 and a lens L3 are cemented. The lens component C3 is composed of a lens L4 that is a single lens. The lens component C4 is composed of a lens L5 that is a single lens. The lens component C5 is composed of a cemented lens in which a lens L6 and a lens L7 are cemented. The lens component C6 is composed of a lens L8 that is a single lens. The lens component C7 is composed of a lens L9 that is a single lens. The lens component C8 is composed of a cemented lens in which a lens L10 and a lens L11 are cemented. The lens component C9 is composed of a lens L12 that is a single lens.

The lens components C1 and C3 each correspond to the front lens component, and the lens components C6 to C9 each correspond to the rear lens component. The film 2 is provided on the edge surfaces of the lens components C1 to C2, C5 to C6, and C8 to C9. The focusing group is composed of the lens components C4 to C7. During focusing on a short range object from the infinite distance object, the lens components forming the focusing group integrally move to the object side.

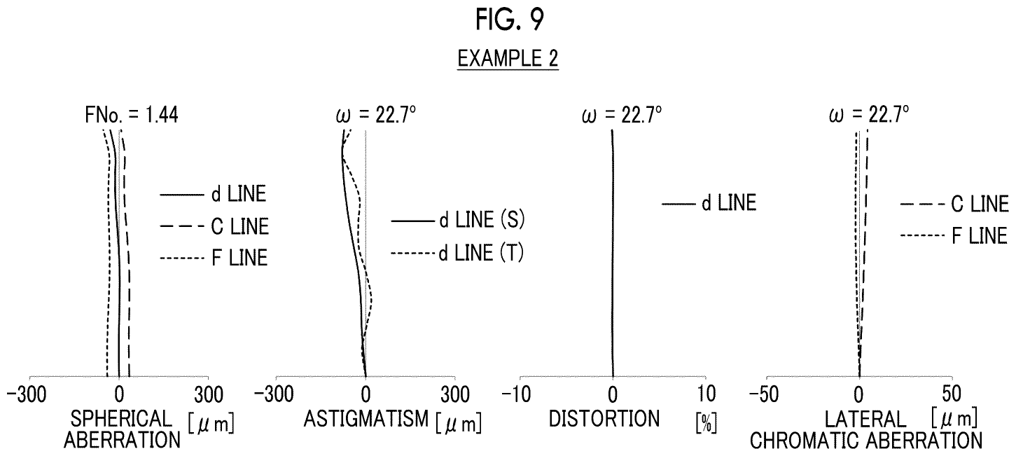

For the optical system according to Example 2, Table 6 shows basic lens data, Table 7 shows specifications, Table 8 shows aspherical coefficients, and FIG. 9 shows each aberration diagram in a state in which the infinite distance object is in focus. In addition, for the front lens component and the rear lens component of the optical system according to Example 2, the presence or absence of the film 2 on the edge surface, the corresponding values of Conditional Expressions (1) to (11), and the proportions A to I are shown in Table 9 and Table 10.

TABLE 6
Example 2

| | | | | | | Outer | | |
|---|---|---|---|---|---|---|---|---|
| | Sn | R | D | Nd | νd | diameter | Film | α − β |
| fC | 1 | −40.3834 | 0.9998 | 1.48749 | 70.44 | 32.00 | Presence | 23.96 |
| | 2 | 38.0997 | 1.4257 | | | | | |
| | 3 | 59.0655 | 7.9999 | 1.69680 | 55.53 | 29.50 | Presence | 24.71 |
| | 4 | −24.2746 | 1.0100 | 1.62004 | 36.26 | 31.00 | Presence | |
| | 5 | 53.1211 | 0.1298 | | | | | |
| | 6 | 42.5413 | 5.1853 | 1.83481 | 42.74 | 29.50 | Absence | 2.64 |
| | 7 | −93.3590 | 4.5879 | | | | | |
| | 8(St) | ∞ | 7.4972 | | | | | |
| | 9 | 20.1819 | 3.2144 | 1.95906 | 17.47 | 25.00 | Absence | |
| | 10 | 34.5549 | 0.6457 | | | | | |
| | 11 | 43.6796 | 0.7998 | 1.84666 | 23.78 | 24.00 | Presence | |
| | 12 | 12.5000 | 5.1200 | 1.59282 | 68.62 | 21.00 | Presence | |
| | 13 | 30.4714 | 4.8427 | | | | | |
| rC | 14 | −15.4860 | 0.8000 | 1.75211 | 25.05 | 23.00 | Presence | 3.57 |
| | 15 | −68.4170 | 0.1298 | | | | | |
| | *16 | 159.8143 | 5.7629 | 1.85135 | 40.10 | 24.00 | Absence | 2.06 |
| | *17 | −17.9951 | 1.5311 | | | | | |
| | 18 | 50.6459 | 5.5320 | 1.91082 | 35.25 | 25.00 | Presence | 24.82 |
| | 19 | −31.0436 | 1.0098 | 1.73037 | 32.23 | 25.00 | Presence | |
| | 20 | 37.8861 | 3.1144 | | | | | |
| | *21 | −50.1906 | 1.5002 | 1.68948 | 31.02 | 26.00 | Presence | 10.25 |
| | *22 | −148.8957 | 10.2560 | | | | | |
| | 23 | ∞ | 2.8500 | 1.51680 | 64.20 | | | |
| | 24 | ∞ | 1.1000 | | | | | |

TABLE 7
Example 2

| | |
|---|---|
| f | 34.01 |
| Bf | 13.24 |
| FNo. | 1.44 |
| 2ω[°] | 45.4 |
| Stφ | 25.61 |
| TL | 76.07 |
| TD | 62.83 |

TABLE 8
Example 2

| Sn | 16 | 17 | 21 | 22 |
|---|---|---|---|---|
| KA | 1.0000000E+00 | 1.0000000E+00 | 1.0000000E+00 | 1.0000000E+00 |
| A3 | 0.0000000E+00 | 0.0000000E+00 | 0.0000000E+00 | 0.0000000E+00 |
| A4 | −6.7892977E−06 | 2.6728027E−05 | 2.0699818E−05 | −2.6025700E−05 |
| A5 | −3.4998037E−06 | −3.1585103E−06 | −3.5609821E−06 | 2.0701497E−05 |
| A6 | 2.6708753E−07 | 3.6167193E−08 | 1.0411116E−06 | −3.2441813E−06 |
| A7 | 4.1719229E−08 | 5.7847224E−08 | −4.6385997E−08 | 2.0830649E−07 |
| A8 | −4.6906387E−09 | −3.6372615E−09 | −1.0004409E−08 | 8.0249345E−09 |
| A9 | −2.1393790E−10 | −3.2271859E−10 | 6.1558719E−10 | −2.2013977E−09 |
| A10 | 3.2807144E−11 | 2.9770156E−11 | 2.8180923E−11 | 7.4088106E−11 |
| A11 | 3.7083422E−13 | 6.2009046E−13 | −1.8453397E−12 | 4.8533222E−12 |
| A12 | −7.9543983E−14 | −7.1537115E−14 | −2.8600819E−14 | −2.7168254E−13 |

TABLE 9
Example 2
(1) FNo/tanω = 3.442

| | Front lens component | | |
|---|---|---|---|
| | C1 | C2 | C3 |
| Presence or absence of | Presence | Presence | Absence |
| film of edge surface | | | |
| Proportion A | 92.5% | | |
| (2) 2.7° < αf − βf < 40° | 23.96° | 24.71° | 2.64° |
| Proportion B | 100% | | |
| (3) 1.1° < αf − βf ≤ 2.7° | 23.96° | 24.71° | 2.64° |
| (4) −2.4 < TD/ff | — | — | −1.390 |
| Proportion C | 0% | | |
| (3) 1.1° < αf − βf ≤ 2.7° | 23.96° | 24.71° | 2.64° |
| (5) TD/Rf < 2.4 | — | — | −0.673 |
| Proportion D | 0% | | |
| (10) 0° < αf − βf ≤ 1.1° | 23.96° | 24.71° | 2.64° |

TABLE 10
Example 2

| | Rear lens component | | | |
|---|---|---|---|---|
| | C6 | C7 | C8 | C9 |
| Presence or absence of | Presence | Absence | Presence | Presence |
| film of edge surface | | | | |
| Proportion E | 90.3% | | | |
| (6) 2.7° < αr − βr < 40° | 3.57° | 2.06° | 24.82° | 10.25° |
| Proportion F | 100% | | | |
| (7) 1.1° < αr − βr ≤ | 3.57° | 2.06° | 24.82° | 10.25° |
| 2.7° | | | | |
| (8) −2.4 < TD/fr | — | −0.178 | — | — |
| Proportion G | 0% | | | |
| (7) 1.1° < αr − βr ≤ | 3.57° | 2.06° | 24.82° | 10.25° |
| 2.7° | | | | |
| (9) −10 < TD/Rr | — | 0.393 | — | — |
| Proportion H | 0% | | | |
| (11) 0° < αr − βr ≤ 1.1° | 3.57° | 2.06° | 24.82° | 10.25° |

| | |
|---|---|
| Proportion I | No corresponding lens component |

### Example 3

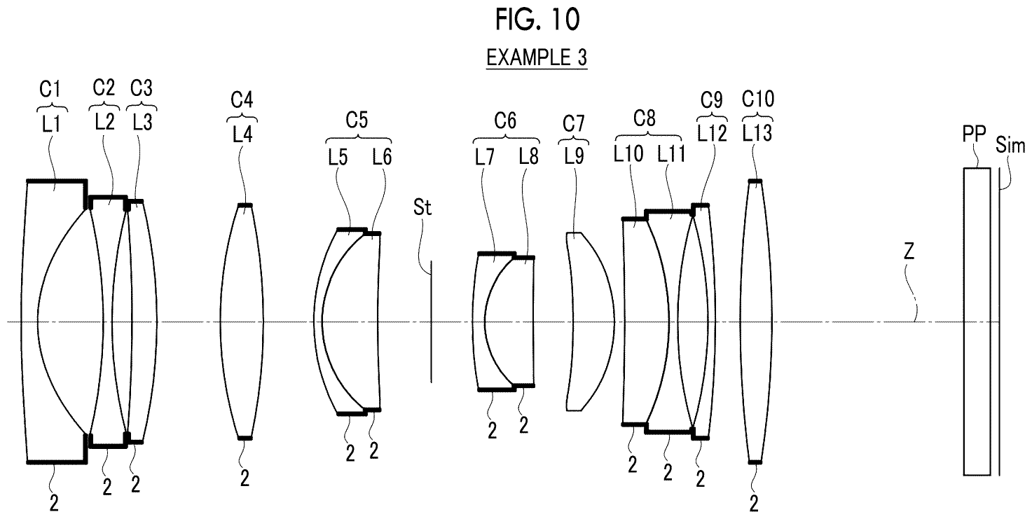

A cross-sectional view of a configuration of an optical system according to Example 3 is shown in FIG. 10. The optical system according to Example 3 comprises, in order from the object side to the image side, lens components C1 to C5, an aperture stop St, and lens components C6 to C10. The lens component C1 is composed of a lens L1 that is a single lens. The lens component C2 is composed of a lens L2 that is a single lens. The lens component C3 is composed of a lens L3 that is a single lens. The lens component C4 is composed of a lens L4 that is a single lens. The lens component C5 is composed of a cemented lens in which a lens L5 and a lens L6 are cemented. The lens component C6 is composed of a cemented lens in which a lens L7 and a lens L8 are cemented. The lens component C7 is composed of a lens L9 that is a single lens. The lens component C8 is composed of a cemented lens in which a lens L10 and a lens L11 are cemented. The lens component C9 is composed of a lens L12 that is a single lens. The lens component C10 is composed of a lens L13 that is a single lens.

The lens components C1 and C4 each correspond to the front lens component, and the lens components C7 to C10 each correspond to the rear lens component. The film 2 is provided on the edge surfaces of the lens components C1 to C6 and C8 to C10. The focusing group is composed of the lens components C5 to C7 and the aperture stop St. During focusing on a short range object from the infinite distance object, the lens components forming the focusing group integrally move to the object side.

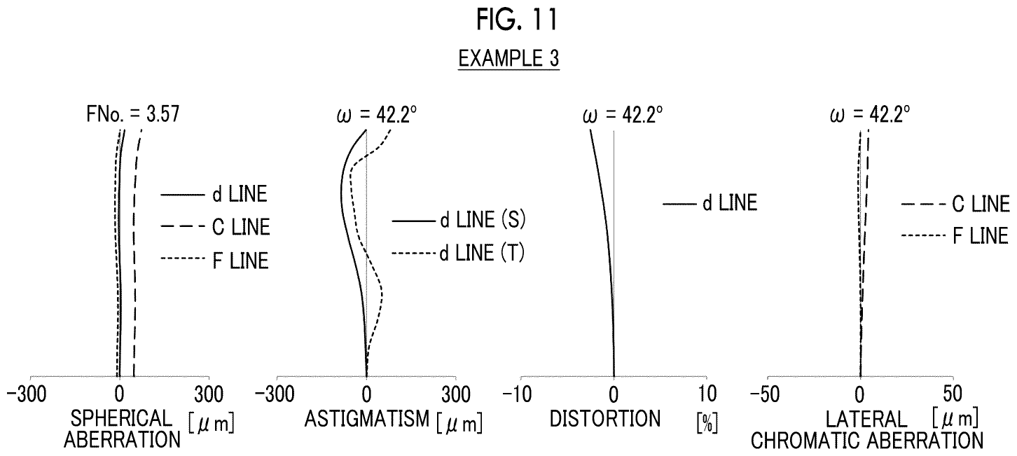

For the optical system according to Example 3, Table 11 shows basic lens data, Table 12 shows specifications, Table 13 shows aspherical coefficients, and FIG. 11 shows each aberration diagram in a state in which the infinite distance object is in focus. In addition, for the front lens component and the rear lens component of the optical system according to Example 3, the presence or absence of the film 2 on the edge surface, the corresponding values of Conditional Expressions (1) to (11), and the proportions A to I are shown in Table 14 and Table 15.

TABLE 11
Example 3

| | | | | | | Outer | | |
|---|---|---|---|---|---|---|---|---|
| | Sn | R | D | Nd | νd | diameter | Film | α − β |
| fC | *1 | 147.3129 | 2.0000 | 1.80999 | 41.01 | 35.00 | Presence | 21.73 |
| | *2 | 17.3859 | 7.9700 | | | | | |
| | 3 | −61.0298 | 1.0500 | 1.49700 | 81.61 | 31.00 | Presence | 11.14 |
| | 4 | 55.9990 | 2.4440 | | | | | |
| | 5 | −175.2376 | 2.9940 | 1.71736 | 29.52 | 30.00 | Presence | 3.67 |
| | 6 | −64.6749 | 7.6770 | | | | | |
| | 7 | 47.9629 | 5.2330 | 1.72000 | 43.69 | 29.00 | Presence | |
| | 8 | −71.4295 | 6.1260 | | | | | 1.32 |
| | 9 | 24.0087 | 1.0000 | 1.80165 | 44.27 | 23.00 | Presence | |
| | 10 | 14.0015 | 6.7130 | 1.60042 | 61.94 | 22.00 | Presence | |
| | 11 | 156.4580 | 6.5130 | | | | | |
| | 12(St) | ∞ | 4.9880 | | | | | |
| | 13 | 48.1421 | 1.5000 | 1.91082 | 35.25 | 17.00 | Presence | |
| | 14 | 10.5912 | 5.7900 | 1.56907 | 71.31 | 16.00 | Presence | |
| | 15 | 346.0071 | 4.8530 | | | | | |
| rC | *16 | −84.0231 | 5.0000 | 1.58913 | 61.15 | 22.00 | Absence | 1.55 |
| | *17 | −18.0076 | 1.2320 | | | | | |
| | 18 | −356.4668 | 5.4070 | 2.00272 | 19.32 | 25.60 | Presence | 19.80 |
| | 19 | −30.0142 | 1.0260 | 1.73800 | 32.33 | 27.50 | Presence | |
| | 20 | 48.3922 | 3.6720 | | | | | |
| | 21 | −48.1026 | 0.9000 | 1.98613 | 16.48 | 29.00 | Presence | 5.47 |
| | 22 | −122.1059 | 3.0200 | | | | | |
| | 23 | 137.7953 | 3.8420 | 1.63545 | 59.73 | 35.00 | Presence | 4.52 |
| | 24 | −115.9825 | 23.3120 | | | | | |
| | 25 | ∞ | 3.2000 | 1.51680 | 64.20 | | | |
| | 26 | ∞ | 1.1000 | | | | | |

TABLE 12
Example 3

| | |
|---|---|
| f | 30.91 |
| Bf | 26.52 |
| FNo. | 3.57 |
| 2ω[°] | 84.4 |
| Stφ | 14.96 |
| TL | 117.47 |
| TD | 90.95 |

TABLE 13
Example 3

| Sn | 1 | 2 | 16 | 17 |
|---|---|---|---|---|
| KA | 1.0000000E+00 | 1.0000000E+00 | 1.0000000E+00 | 1.0000000E+00 |
| A3 | 0.0000000E+00 | 0.0000000E+00 | 0.0000000E+00 | 0.0000000E+00 |
| A4 | 1.7190323E−06 | −1.0324755E−05 | −3.6874743E−05 | −1.7507432E−05 |
| A5 | −7.4474335E−07 | −9.9518618E−07 | 1.5262016E−06 | 1.8963888E−06 |
| A6 | 3.0051321E−08 | −6.4950083E−09 | 2.2784479E−07 | −1.6630172E−07 |
| A7 | 8.1417469E−12 | 1.0528595E−09 | −9.8209300E−08 | −4.0718008E−08 |
| A8 | 2.6419440E−11 | −1.9802457E−10 | 4.2866430E−10 | 3.0729611E−09 |
| A9 | −8.4613032E−13 | 9.3801528E−12 | 1.4337539E−09 | 2.2019263E−10 |
| A10 | −6.7674963E−14 | −2.6840622E−14 | 4.1053517E−11 | −1.0135846E−11 |
| A11 | −5.2825214E−15 | −9.6141003E−14 | −1.4808362E−11 | −1.3635971E−12 |
| A12 | 1.3685955E−17 | 9.2320265E−15 | −7.4799199E−13 | 3.6925212E−14 |
| A13 | −2.1817230E−17 | −9.7218804E−16 | 9.9226988E−14 | −2.6847120E−14 |
| A14 | 1.9880799E−18 | 3.3672325E−17 | 2.1856025E−15 | 1.3212027E−15 |
| A15 | 7.8661839E−20 | 4.2370872E−18 | 2.2178857E−16 | 1.8274698E−16 |
| A16 | 9.0261546E−21 | −9.1536371E−19 | −2.2420853E−16 | 3.5944816E−17 |
| A17 | −5.4358767E−22 | 7.0329374E−20 | 3.2929455E−17 | −3.1433068E−18 |
| A18 | −4.4806487E−23 | −3.5736344E−22 | 2.2161945E−19 | −6.0753510E−19 |
| A19 | 2.0403062E−24 | −1.5453784E−22 | −2.7567893E−19 | 6.0854810E−20 |
| A20 | −5.5439226E−27 | 3.7714093E−24 | 1.1764954E−20 | −9.4474266E−22 |

TABLE 14
Example 3
(1) FNo/tanω = 3.937

| | Front lens component | | | |
|---|---|---|---|---|
| | C1 | C2 | C3 | C4 |
| Presence or absence of | Presence | Presence | Presence | Presence |
| film of edge surface | | | | |
| Proportion A | 100% | | | |
| (2) 2.7° < αf − βf < 40° | 21.73° | 11.14° | 3.67° | 1.32° |
| Proportion B | 100% | | | |
| (3) 1.1° < αf − βf ≤ | 21.73° | 11.14° | 3.67° | 1.32° |
| 2.7° | | | | |
| (4) −2.4 < TD/ff | — | — | — | −4.698 |
| Proportion C | No corresponding lens component | | | |
| (3) 1.1° < αf − βf ≤ | 21.73° | 11.14° | 3.67° | 1.32° |
| 2.7° | | | | |
| (5) TD/Rf < 2.4 | — | — | — | −1.273 |
| Proportion D | 100% | | | |
| (10) 0° < αf − βf ≤ 1.1° | 21.73° | 11.14° | 3.67° | 1.32° |

TABLE 15
Example 3

| | Rear lens component | | | |
|---|---|---|---|---|
| | C7 | C8 | C9 | C10 |
| Presence or absence of | Absence | Presence | Presence | Presence |
| film of edge surface | | | | |
| Proportion E | 89.80% | | | |
| (6) 2.7° < αr − βr < | 1.55° | 19.80° | 5.47° | 4.52° |
| 40° | | | | |
| Proportion F | 100% | | | |
| (7) 1.1° < αr − βr ≤ | 1.55° | 19.80° | 5.47° | 4.52° |
| 2.7° | | | | |
| (8) −2.4 < TD/fr | −0.957 | — | — | — |
| Proportion G | 0% | | | |
| (7) 1.1° < αr − βr ≤ | 1.55° | 19.80° | 5.47° | 4.52° |
| 2.7° | | | | |
| (9) −10 < TD/Rr | −1.082 | — | — | — |
| Proportion H | 0% | | | |
| (11) 0° < αr − βr ≤ | 1.55° | 19.80° | 5.47° | 4.52° |
| 1.1° | | | | |

| | |
|---|---|
| Proportion I | No corresponding lens component |

### Example 4

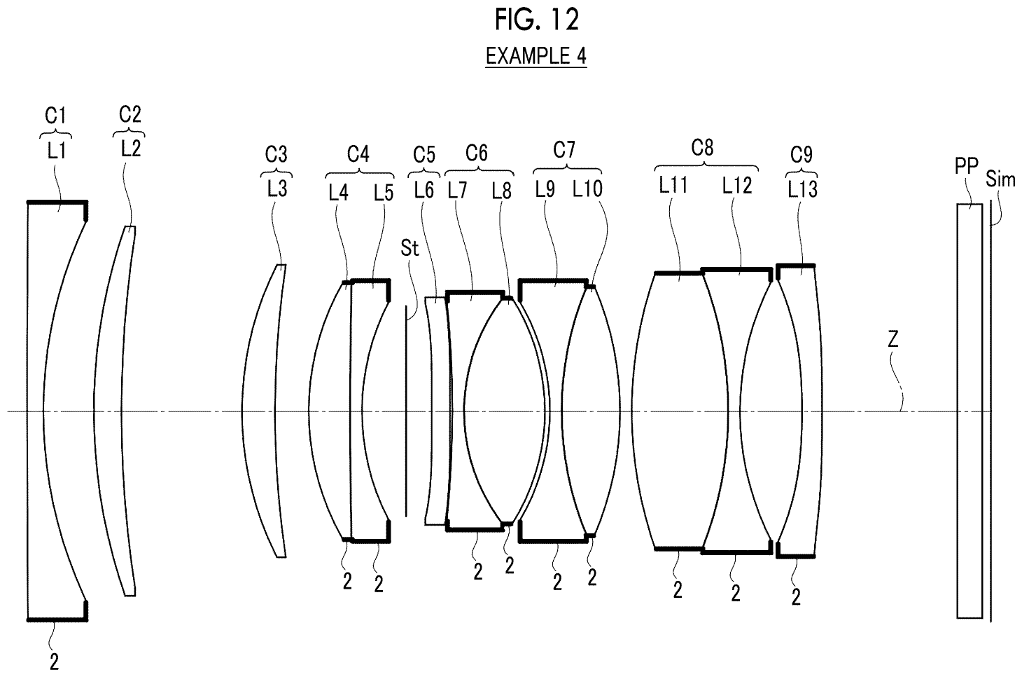

A cross-sectional view of a configuration of an optical system according to Example 4 is shown in FIG. 12. The optical system according to Example 4 comprises, in order from the object side to the image side, lens components C1 to C4, an aperture stop St, and lens components C5 to C9. The lens component C1 is composed of a lens L1 that is a single lens. The lens component C2 is composed of a lens L2 that is a single lens. The lens component C3 is composed of a lens L3 that is a single lens. The lens component C4 is composed of a cemented lens in which a lens L4 and a lens L5 are cemented. The lens component C5 is composed of a lens L6 that is a single lens. The lens component C6 is composed of a cemented lens in which a lens L7 and a lens L8 are cemented. The lens component C7 is composed of a cemented lens in which a lens L9 and a lens L10 are cemented. The lens component C8 is composed of a cemented lens in which a lens L11 and a lens L12 are cemented. The lens component C9 is composed of a lens L13 that is a single lens.

The lens components C1 and C3 each correspond to the front lens component, and the lens components C7 to C9 each correspond to the rear lens component. The film 2 is provided on the edge surfaces of the lens components C1, C4, and C6 to C9. The focusing group is composed of the lens components C3 to C7 and the aperture stop St. During focusing on a short range object from the infinite distance object, the lens components forming the focusing group integrally move to the object side.

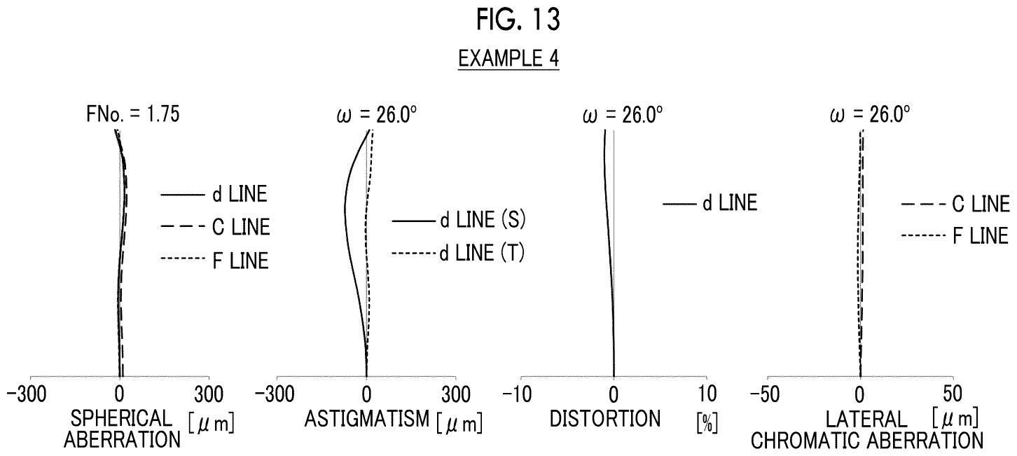

For the optical system according to Example 4, Table 16 shows basic lens data, Table 17 shows specifications, Table 18 shows aspherical coefficients, and FIG. 13 shows each aberration diagram in a state in which the infinite distance object is in focus. In addition, for the front lens component and the rear lens component of the optical system according to Example 4, the presence or absence of the film 2 on the edge surface, the corresponding values of Conditional Expressions (1) to (11), and the proportions A to I are shown in Table 19 and Table 20.

TABLE 16
Example 4

| | | | | | | Outer | | |
|---|---|---|---|---|---|---|---|---|
| | Sn | R | D | Nd | νd | diameter | Film | α − β |
| fC | 1 | 3395.1569 | 2.1000 | 1.51742 | 52.15 | 54.50 | Presence | 15.45 |
| | 2 | 58.1682 | 6.4667 | | | | | |
| | 3 | 74.0322 | 3.5505 | 1.77535 | 50.30 | 48.00 | Absence | 2.36 |
| | 4 | 153.3942 | 15.4200 | | | | | |
| | 5 | 42.4814 | 4.2313 | 2.00069 | 25.46 | 38.00 | Absence | 0.87 |
| | 6 | 130.7358 | 4.3112 | | | | | |
| | 7 | 33.8928 | 5.3234 | 1.49700 | 81.61 | 33.50 | Presence | |
| | 8 | 848.1439 | 1.5000 | 1.84666 | 23.78 | 34.00 | Presence | |
| | 9 | 30.8686 | 5.6532 | | | | | |
| | 10(St) | ∞ | 3.2952 | | | | | |
| | *11 | −1998.5918 | 2.3248 | 1.80225 | 45.45 | 31.60 | Absence | |
| | *12 | −34995.5964 | 0.3024 | | | | | |
| | 13 | −142.3892 | 1.5000 | 1.59270 | 35.45 | 31.00 | Presence | |
| | 14 | 24.1595 | 10.2742 | 1.55032 | 75.50 | 29.50 | Presence | |
| | 15 | −27.6669 | 0.6305 | | | | | |
| rC | 16 | −28.0490 | 1.5200 | 1.77047 | 29.74 | 34.00 | Presence | |
| | 17 | 42.2219 | 7.4809 | 1.90200 | 25.26 | 32.50 | Presence | 5.44 |
| | 18 | −41.4373 | 1.5000 | | | | | |
| | 19 | 54.6186 | 12.3453 | 1.84850 | 43.79 | 36.00 | Presence | |
| | 20 | −49.7007 | 1.5200 | 1.59551 | 39.22 | 37.00 | Presence | 30.61 |
| | 21 | 37.3059 | 7.9438 | | | | | |
| | *22 | −76.8164 | 2.5455 | 1.68948 | 31.02 | 38.00 | Presence | 13.78 |
| | *23 | −1406.3294 | 17.2924 | | | | | |
| | 24 | ∞ | 3.2000 | 1.51680 | 64.20 | | | |
| | 25 | ∞ | 1.1000 | | | | | |

TABLE 17
Example 4

| | |
|---|---|
| f | 56.67 |
| Bf | 20.50 |
| FNo. | 1.75 |
| 2ω[°] | 52.0 |
| Stφ | 27.29 |
| TL | 122.24 |
| TD | 101.74 |

TABLE 18
Example 4

| Sn | 11 | 12 | 22 | 23 |
|---|---|---|---|---|
| KA | 1.0000000E+00 | 1.0000000E+00 | 1.0000000E+00 | 1.0000000E+00 |
| A4 | −2.0370108E−05 | −1.4890456E−05 | −2.5350781E−05 | −2.0566239E−05 |
| A6 | −2.2837244E−08 | −1.4092898E−08 | 5.0780164E−08 | 5.3699159E−08 |
| A8 | 1.5881928E−10 | 1.4530204E−10 | −5.4993528E−11 | −5.6857976E−11 |
| A10 | −2.7238168E−13 | −2.5033093E−13 | 4.3033371E−14 | 4.1725261E−14 |

TABLE 19
Example 4
(1) FNo/tanω = 3.588

| | Front lens component | | |
|---|---|---|---|
| | C1 | C2 | C3 |
| Presence or absence of | Presence | Absence | Absence |
| film of edge surface | | | |
| Proportion A | 79.7% | | |
| (2) 2.7° < αf − βf < 40° | 15.45° | 2.36° | 0.87° |
| Proportion B | 100% | | |
| (3) 1.1° < αf − βf ≤ 2.7° | 15.45° | 2.36° | 0.87° |
| (4) −2.4 < TD/ff | — | −0.889 | — |
| Proportion C | 0% | | |
| (3) 1.1° < αf − βf ≤ 2.7° | 15.45° | 2.36° | 0.87° |
| (5) TD/Rf < 2.4 | — | 0.663 | — |
| Proportion D | 0% | | |
| (10) 0° < αf − βf ≤ 1.1° | 15.45° | 2.36° | 0.87° |

TABLE 20
Example 4

| | Rear lens component | | |
|---|---|---|---|
| | C7 | C8 | C9 |
| Presence or absence of film | Presence | Presence | Presence |
| of edge surface | | | |
| Proportion E | 100% | | |
| (6) 2.7° < αr − βr < 40° | 5.44° | 30.61° | 13.78° |
| Proportion F | 100% | | |
| (7) 1.1° < αr − βr ≤ 2.7° | 5.44° | 30.61° | 13.78° |
| (8) −2.4 < TD/fr | — | — | — |
| Proportion G | No corresponding lens component | | |
| (7) 1.1° < αr − βr ≤ 2.7° | 5.44° | 30.61° | 13.78° |
| (9) −10 < TD/Rr | — | — | — |
| Proportion H | No corresponding lens component | | |
| (11) 0° < αr − βr ≤ 1.1° | 5.44° | 30.61° | 13.78° |

| | |
|---|---|
| Proportion I | 0% |

### Example 5

A cross-sectional view of a configuration of an optical system according to Example 5 is shown in FIG. 14. The optical system according to Example 5 is a zoom lens. In FIG. 14, the wide angle end state is shown in an upper part labeled “Wide”, and the telephoto end state is shown in a lower part labeled “Tele”. The optical system according to Example 5 consists of, in order from the object side to the image side, a first lens group G1 and a subsequent group GR. The subsequent group GR consists of, in order from the object side to the image side, a second lens group G2, a third lens group G3, a fourth lens group G4, and a fifth lens group G5. During changing magnification, the second lens group G2 and the fourth lens group G4 move along the optical axis Z by changing the spacings between the adjacent lens groups, and the first lens group G1, the third lens group G3, and the fifth lens group G5 are fixed with respect to the image plane Sim. Between the upper part and the lower part of FIG. 14, an approximate movement trajectory during changing magnification from the wide angle end to the telephoto end is indicated by an arrow for the lens group that moves during changing magnification, and a straight line segment in an up-down direction is indicated for the lens group that is fixed during changing magnification.

The first lens group G1 is composed of, in order from the object side to the image side, lens components C1 to C3. The second lens group G2 is composed of, in order from the object side to the image side, lens components C4 to C7. The third lens group G3 is composed of, in order from the object side to the image side, an aperture stop St and lens components C8 and C9. The fourth lens group G4 is composed of a lens component C10. The fifth lens group G5 is composed of, in order from the object side to the image side, lens components C11 to C13.

The lens component C1 is composed of a cemented lens in which a lens L1 and a lens L2 are cemented. The lens component C2 is composed of a lens L3 that is a single lens. The lens component C3 is composed of a lens L4 that is a single lens. The lens component C4 is composed of a lens L5 that is a single lens. The lens component C5 is composed of a lens L6 that is a single lens. The lens component C6 is composed of a lens L7 that is a single lens. The lens component C7 is composed of a lens L8 that is a single lens. The lens component C8 is composed of a lens L9 that is a single lens. The lens component C9 is composed of a cemented lens in which a lens L10 and a lens L11 are cemented. The lens component C10 is composed of a cemented lens in which a lens L12 and a lens L13 are cemented.” The lens component C11 is composed of a lens L14 that is a single lens. The lens component C12 is composed of a lens L15 that is a single lens. The lens component C13 is composed of a lens L16 that is a single lens.

In the wide angle end state, the lens components C1 to C7 each correspond to the front lens component, and the lens components C11 to C13 each correspond to the rear lens component. In the telephoto end state, the lens components C1 to C3 each correspond to the front lens component, and the lens components C10 to C13 each correspond to the rear lens component. The film 2 is provided on the edge surfaces of the lens components C1, C4 to C5, C7, C9 to C10, and C12 to C13. The focusing group is composed of the lens component C10. During focusing on a short range object from the infinite distance object, the lens components forming the focusing group integrally move to the image side. A rightward arrow attached on the fourth lens group G4 in the lower part diagram indicates that the fourth lens group G4 moves to the image side during focusing on the short range object from the infinite distance object.

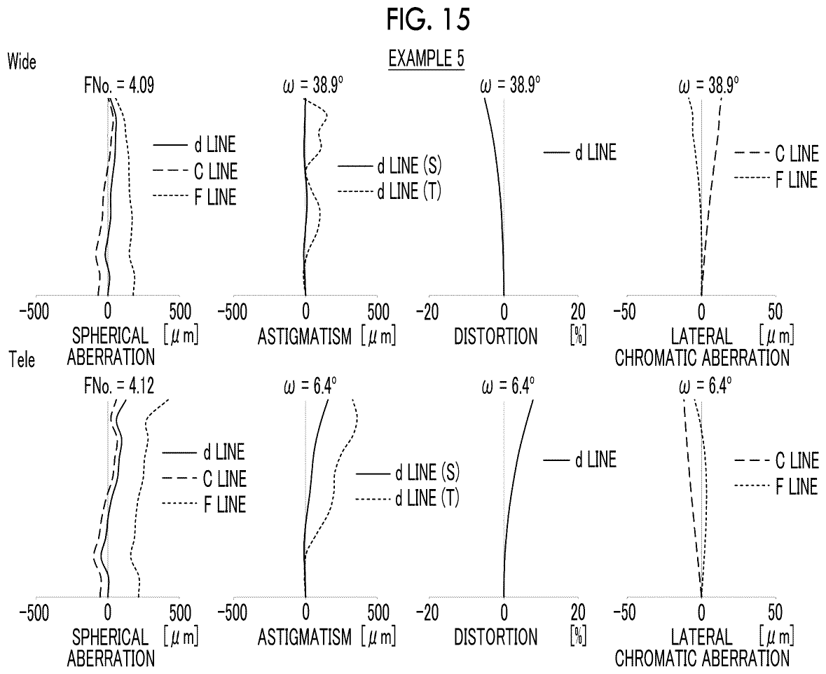

For the optical system according to Example 5, Table 21 shows basic lens data, Table 22 shows specifications, Table 23 shows aspherical coefficients, and FIG. 15 shows each aberration diagram in a state in which the infinite distance object is in focus.

In Table 21, the symbol DD[ ] is used for the variable surface spacings during changing magnification, and the surface number on the object side of the spacing is provided inside [ ] and is described in the column of the surface spacings. In the field of “Wide α−β”, the value of αf−βf is shown for the front lens component at the wide angle end, and the value of αr−βr is shown for the rear lens component. In the field of “Tele α−β”, the values of αf−βf are shown for the front lens component at the telephoto end, and the values of αr−βr are shown for the rear lens component. In Table 21, the description of “fC” and “rC” is omitted.

Table 22 shows the specifications and the variable surface spacings of the optical system of Example 5. In Table 22, the column labeled “Wide” shows each value in the wide angle end state, and the column labeled “Tele” shows each value in the telephoto end state. Table 22 also shows a zoom magnification Zr. FIG. 15 shows each aberration diagram of the optical system of Example 5 in a state in which the infinite distance object is in focus. In FIG. 15, the upper part labeled “Wide” shows the aberrations in the wide angle end state, and the lower part labeled “Tele” shows the aberrations in the telephoto end state.

TABLE 21
Example 5

| | | | | | Outer | | Wide | Tele |
|---|---|---|---|---|---|---|---|---|
| Sn | R | D | Nd | νd | diameter | Film | α − β | α − β |
| 1 | 192.9221 | 1.7000 | 1.85000 | 27.03 | 56.00 | Presence | 16.07 | 16.07 |
| 2 | 55.8776 | 8.2750 | 1.53775 | 74.70 | 54.00 | Presence | | |
| 3 | −19857.1205 | 0.1200 | | | | | | |
| 4 | 97.4892 | 3.5130 | 1.59283 | 68.63 | 50.00 | Absence | 1.97 | 1.97 |
| 5 | 357.3671 | 0.1190 | | | | | | |
| 6 | 45.9156 | 5.2120 | 1.79828 | 48.27 | 44.00 | | 1.63 | 1.63 |
| 7 | 158.1434 | DD[7] | | | | | | |
| *8 | 220.9427 | 1.2000 | 1.80610 | 40.73 | 26.00 | Presence | 5.44 | |
| *9 | 12.9080 | 6.3380 | | | | | | |
| 10 | −27.0447 | 0.6490 | 1.77535 | 50.30 | 22.00 | Presence | 2.41 | |
| 11 | 49.1182 | 0.1190 | | | | | | |
| 12 | 31.0232 | 4.3170 | 1.84666 | 23.78 | 21.00 | Absence | 0.38 | |
| 13 | −31.0232 | 0.6340 | | | | | | |
| 14 | −22.6511 | 0.6000 | 1.88300 | 40.85 | 20.60 | Presence | 1.13 | |
| 15 | −83.3290 | DD[15] | | | | | | |
| 16(St) | ∞ | 1.2000 | | | | | | |
| *17 | 18.2045 | 4.4890 | 1.48789 | 83.67 | 20.00 | Absence | | |
| *18 | −47.7735 | 1.3660 | | | | | | |
| 19 | 29.9722 | 0.8010 | 1.91082 | 35.25 | 19.80 | Presence | | |
| 20 | 13.0000 | 6.8240 | 1.53775 | 74.70 | 19.00 | Presence | | |
| 21 | −23.7988 | DD[21] | | | | | | |
| 22 | −75.5025 | 2.0150 | 1.89502 | 25.23 | 15.00 | Presence | | 3.04 |
| 23 | −18.7696 | 0.6100 | 1.76963 | 51.04 | 16.00 | Presence | | |
| 24 | 23.6824 | DD[24] | | | | | | |
| *25 | −178.4122 | 5.1550 | 1.58313 | 59.46 | 24.00 | Absence | 1.69 | 1.69 |
| *26 | −16.6219 | 0.1200 | | | | | | |
| 27 | −20.4508 | 0.8100 | 2.00272 | 19.32 | 25.00 | Presence | 5.87 | 5.87 |
| 28 | −52.2877 | 4.4750 | | | | | | |
| 29 | −199.2175 | 6.1240 | 1.72073 | 29.78 | 29.00 | Presence | 14.83 | 14.83 |
| 30 | −43.1534 | 19.6773 | | | | | | |
| 31 | ∞ | 2.8500 | 1.51680 | 64.20 | | | | |
| 32 | ∞ | 1.1000 | | | | | | |

TABLE 22
Example 5

| | Wide | Tele |
|---|---|---|
| Zr | 1.0 | 6.3 |
| f | 18.54 | 116.77 |
| Bf | 22.66 | 22.66 |
| FNo. | 4.09 | 4.12 |
| 2ω[°] | 77.8 | 12.8 |
| Stφ | 14.33 | 16.51 |
| TL | 144.32 | 144.32 |
| TD | 121.66 | 121.66 |
| DD[7] | 1.01 | 31.03 |
| DD[15] | 31.02 | 1.00 |
| DD[21] | 1.04 | 12.53 |
| DD[24] | 21.80 | 10.31 |

TABLE 23
Example 5

| Sn | 8 | 9 |
|---|---|---|
| KA | 1.0000000E+00 | 1.0000000E+00 |
| A4 | 6.3654280E−05 | 5.8115700E−05 |
| A6 | −1.6520578E−06 | −8.6702710E−07 |
| A8 | 3.6308297E−08 | −4.5783717E−08 |
| A10 | −6.2436489E−10 | 3.8246956E−09 |
| A12 | 7.5884189E−12 | −1.3330761E−10 |
| A14 | −6.0903631E−14 | 2.6082780E−12 |
| A16 | 3.0342366E−16 | −2.9426472E−14 |
| A18 | −8.4569318E−19 | 1.7856370E−16 |
| A20 | 1.0050279E−21 | −4.5150703E−19 |

| Sn | 17 | 18 |
|---|---|---|
| KA | 1.0000000E+00 | 1.0000000E+00 |
| A3 | 0.0000000E+00 | 0.0000000E+00 |
| A4 | −3.8865422E−05 | 7.1075371E−05 |
| A5 | 7.6564967E−05 | −2.3245540E−05 |
| A6 | −7.1121281E−05 | 8.8240861E−06 |
| A7 | 3.1399739E−05 | −1.6886838E−06 |
| A8 | −7.0470848E−06 | 1.8063804E−07 |
| A9 | 5.5583077E−07 | −1.8197456E−08 |
| A10 | 9.7347054E−08 | 2.8022294E−09 |
| A11 | −2.8941874E−08 | −6.9908347E−11 |
| A12 | 2.6732043E−09 | −6.6561840E−11 |
| A13 | −2.3823750E−11 | 9.3073733E−12 |
| A14 | −1.4334971E−11 | −2.8836404E−13 |
| A15 | 1.0709284E−12 | −1.8458979E−14 |
| A16 | −2.5308020E−14 | 1.0024286E−15 |
| Sn | 25 | 26 |
| KA | 1.0000000E+00 | 1.0000000E+00 |
| A4 | −3.3313022E−07 | 1.5864674E−05 |
| A6 | −3.1035733E−07 | 4.6814967E−07 |
| A8 | 1.3953513E−08 | −2.8075495E−08 |
| A10 | −1.9091620E−10 | 9.8406524E−10 |
| A12 | −7.6081743E−13 | −1.9031014E−11 |
| A14 | 5.1744107E−14 | 2.1392501E−13 |
| A16 | −5.9555663E−16 | −1.3822383E−15 |
| A18 | 2.9430982E−18 | 4.7328661E−18 |
| A20 | −5.4890319E−21 | −6.6078617E−21 |

For the front lens component and the rear lens component of the optical system according to Example 5, the presence or absence of the film 2 on the edge surface, the corresponding values of Conditional Expressions (1) to (11), and the proportions A to I are shown in Table 24 to Table 27. Table 24 and Table 25 show values in the wide angle end state. Tables 26 and 27 show values in the telephoto end state.

TABLE 24
Example 5 Wide
(1) FNo/tanω = 5.069

| | Front lens component | | | | | | |
|---|---|---|---|---|---|---|---|
| | C1 | C2 | C3 | C4 | C | C6 | C7 |
| Presence or absence of | Presence | Absence | Absence | Presence | Presence | Absence | Presence |
| film of edge surface | | | | | | | |
| Proportion A | 85.2% | | | | | | |
| (2) 2.7° < αf − βf < 40° | 16.07° | 1.97° | 1.63° | 5.44° | 2.41° | 0.38° | 1.13° |
| Proportion B | 100% | | | | | | |
| (3) 1.1° < αf − βf ≤ 2.7° | 16.07° | 1.97° | 1.63° | 5.44° | 2.41° | 0.38° | 1.13° |
| (4) −2.4 < TD/ff | — | −0.138 | 0.404 | — | −4.524 | — | −2.496 |
| Proportion C | 0% | | | | | | |
| (3) 1.1° < αf − βf ≤ 2.7° | 16.07° | 1.97° | 1.63° | 5.44° | 2.41° | 0.38° | 1.13° |
| (5) TD/Rf <2.4 | — | 0.340 | 0.769 | — | 2.477 | — | −1.460 |
| Proportion D | 0% | | | | | | |
| (10) 0° < αf − βf ≤ 1.1° | 16.07° | 1.97° | 1.63° | 5.44° | 2.41° | 0.38° | 1.13° |

TABLE 25
Example 5 Wide

| | Rear lens component | | |
|---|---|---|---|
| | C11 | C12 | C13 |
| Presence or absence of film | Absence | Presence | Presence |
| of edge surface | | | |
| Proportion E | 88.5% | | |
| (6) 2.7° < αr − βr < 40° | 1.69° | 5.87° | 14.83° |
| Proportion F | 100% | | |
| (7) 1.1° < αr − βr ≤ 2.7° | 1.69° | 5.87° | 14.83° |
| (8) −2.4 < TD/fr | −1.509 | — | — |
| Proportion G | 0% | | |
| (7) 1.1° < αr − βr ≤ 2.7° | 1.69° | 5.87° | 14.83° |
| (9) −10 < TD/Rr | −0.682 | — | — |
| Proportion H | 0% | | |
| (11) 0° < αr − βr ≤ 1.1° | 1.69° | 5.87° | 14.83° |

| | |
|---|---|
| Proportion I | 0% |

TABLE 26
Example 5 Tele

| | Front lens component | | |
|---|---|---|---|
| | C1 | C2 | C3 |
| Presence or absence of | Presence | Absence | Absence |
| film of edge surface | | | |
| Proportion A | 89.7% | | |
| (2) 2.7° < αf − βf < 40° | 16.07° | 1.97° | 1.63° |
| Proportion B | 100% | | |
| (3) 1.1° < αf − βf ≤ 2.7° | 16.07° | 1.97° | 1.63° |
| (4) −2.4 < TD/ff | — | −0.138 | 0.404 |
| Proportion C | 0% | | |
| (3) 1.1° < αf − βf ≤ 2.7° | 16.07° | 1.97° | 1.63° |
| (5) TD/Rf < 2.4 | — | 0.340 | 0.769 |
| Proportion D | 0% | | |
| (10) 0° < αf − βf ≤ 1.1° | 16.07° | 1.97° | 1.63° |

TABLE 27
Example 5 Tele

| | Rear lens component | | | |
|---|---|---|---|---|
| | C10 | C11 | C12 | C13 |
| Presence or absence of | Presence | Absence | Presence | Presence |
| film of edge surface | | | | |
| Proportion E | 91.1% | | | |
| (6) 2.7° < αr − βr < 40° | 3.04° | 1.69° | 5.87° | 14.83° |
| Proportion F | 100% | | | |
| (7) 1.1° < αr − βr ≤ | 3.04° | 1.69° | 5.87° | 14.83° |
| 2.7° | | | | |
| (8) −2.4 < TD/fr | — | −1.509 | — | — |
| Proportion G | 0% | | | |
| (7) 1.1° < αr − βr ≤ | 3.04° | 1.69° | 5.87° | 14.83° |
| 2.7° | | | | |
| (9) −10 < TD/Rr | — | −0.682 | — | — |
| Proportion H | 0% | | | |
| (11) 0° < αr − βr ≤ 1.1° | 3.04° | 1.69° | 5.87° | 14.83° |

| | |
|---|---|
| Proportion I | No corresponding lens component |

While the technology of the present disclosure has been described above using the embodiment and the examples, the technology of the present disclosure is not limited to the embodiment and the examples, and various modifications can be made. For example, the number of lenses constituting the optical system, the number of lens components, and the number of lens groups are not limited to those in the examples described above. The variable magnification optical system is not limited to the zoom lens, and may be a varifocal lens. The curvature radius, the surface spacing, the refractive index, the Abbe number, the aspherical coefficient, and the like of each lens are not limited to the values shown in the examples, and different values may be used.

In addition, the use of the optical system according to the present disclosure is not limited to the digital camera. The optical system according to the present disclosure can be applied to various devices such as a film camera, a video camera, a terminal camera, a camera for cinematography, and a surveillance camera.

In regard with the embodiment and the examples described above, the following supplementary notes are further disclosed.

### [Supplementary Note 1]

An optical system comprising: at least one lens component in a case in which one lens component is one single lens or one cemented lens, in which in a case in which an outer peripheral surface of the lens component parallel to an optical axis is defined as an edge surface, a distance, on the optical axis, from a lens surface of the optical system closest to an object side to a lens surface of the optical system closest to an image side is denoted by TD, and the lens component, in which at least a part of the lens component is located in a range of 0.3×TD from the lens surface of the optical system closest to the object side to the image side on the optical axis, among the lens components included in the optical system is defined as a front lens component, a film having a light reflectivity of less than 30% is provided on 50% or more of a total area of the edge surfaces of all the front lens components.

### [Supplementary Note 2]

The optical system according to supplementary note 1, in which in a case in which an open F-number of the optical system in a state in which an infinite distance object is in focus is denoted by FNo, a maximum half angle of view of the optical system in a state in which the infinite distance object is in focus is denoted by ω, and FNo and ω are values at a wide angle end in a case in which the optical system is a variable magnification optical system, Conditional Expression (1) is satisfied, which is represented by 1<FNo/tan ω<10 (1).

### [Supplementary Note 3]

The optical system according to supplementary note 1 or 2, in which in a case in which an intersection between the lens surface of the optical system closest to the object side and the optical axis is defined as a front intersection, and for each of the front lens components, an angle between a line connecting the front intersection and a point of the edge surface closest to the object side and the optical axis is denoted by αf, an angle between a line connecting the front intersection and a point of the edge surface closest to the image side and the optical axis is denoted by βf, and units of αf and βf are degrees, the film is provided on 50% or more of a total area of the edge surfaces of all the front lens components satisfying Conditional Expression (2), which is represented by 2.7°<αf−βf<40° (2).

### [Supplementary Note 4]

The optical system according to any one of supplementary notes 1 to 3, in which in a case in which an intersection between the lens surface of the optical system closest to the object side and the optical axis is defined as a front intersection, N is defined as a natural number of 2 or more, and for an N-th front lens component from the object side, an angle between a line connecting the front intersection and a point of the edge surface closest to the object side and the optical axis is denoted by αf, an angle between a line connecting the front intersection and a point of the edge surface closest to the image side and the optical axis is denoted by βf, units of αf and βf are degrees, and a composite focal length from the front lens component closest to the object side to an (N−1)th front lens component from the object side is denoted by ff, a proportion of an area on which the film is provided is 30% or less of a total area of the edge surfaces of all the front lens components satisfying Conditional Expressions (3) and (4), which are represented by 1.1°<αf−βf≤2.7° (3), and −2.4<TD/ff (4).

### [Supplementary Note 5]

The optical system according to any one of supplementary notes 1 to 4, in which in a case in which an intersection between the lens surface of the optical system closest to the object side and the optical axis is defined as a front intersection, N is defined as a natural number of 2 or more, and for an N-th front lens component from the object side, an angle between a line connecting the front intersection and a point of the edge surface closest to the object side and the optical axis is denoted by αf, an angle between a line connecting the front intersection and a point of the edge surface closest to the image side and the optical axis is denoted by βf, units of αf and βf are degrees, and a paraxial curvature radius of a surface, which is closest to the image side, of the N-th front lens component from the object side is denoted by Rf, a proportion of an area on which the film is provided is 30% or less of a total area of the edge surfaces of all the front lens components satisfying Conditional Expressions (3) and (5), which are represented by 1.1°<αf−βf≤2.7° (3), and TD/Rf<2.4 (5).

### [Supplementary Note 6]

The optical system according to any one of supplementary notes 1 to 5, in which in a case in which an intersection between the lens surface of the optical system closest to the object side and the optical axis is defined as a front intersection, for each of the front lens components, an angle between a line connecting the front intersection and a point of the edge surface closest to the object side and the optical axis is denoted by αf, an angle between a line connecting the front intersection and a point of the edge surface closest to the image side and the optical axis is denoted by βf, and units of αf and βf are degrees, the lens component, in which at least a part of the lens component is located in a range of 0.3×TD from the lens surface of the optical system closest to the image side to the object side on the optical axis, among the lens components included in the optical system is defined as a rear lens component, an intersection between the lens surface of the optical system closest to the image side and the optical axis is defined as a rear intersection, and for each of the rear lens components, an angle between a line connecting the rear intersection and a point of the edge surface closest to the image side and the optical axis is denoted by αr, an angle between a line connecting the rear intersection and a point of the edge surface closest to the object side and the optical axis is denoted by βr, and units of αr and βr are degrees, a proportion of an area on which the film is provided is 30% or less of a total area of the edge surfaces of all the front lens components satisfying Conditional Expression (10) and the edge surfaces of all the rear lens components satisfying Conditional Expression (11), Conditional Expressions (10) and (11) being represented by 0°<αf−βf≤1.1° (10), and 0°<αr−βr≤1.1° (11).

### [Supplementary Note 7]

An optical system comprising: at least one lens component in a case in which one lens component is one single lens or one cemented lens, in which in a case in which an outer peripheral surface of the lens component parallel to an optical axis is defined as an edge surface, a distance, on the optical axis, from a lens surface of the optical system closest to an object side to a lens surface of the optical system closest to an image side is denoted by TD, and the lens component, in which at least a part of the lens component is located in a range of 0.3×TD from the lens surface of the optical system closest to the image side to the object side on the optical axis, among the lens components included in the optical system is defined as a rear lens component, a film having a light reflectivity of less than 30% is provided on 50% or more of a total area of the edge surfaces of all the rear lens components.

### [Supplementary Note 8]

The optical system according to supplementary note 7, in which in a case in which an intersection between the lens surface of the optical system closest to the image side and the optical axis is defined as a rear intersection, and for each of the rear lens components, an angle between a line connecting the rear intersection and a point of the edge surface closest to the image side and the optical axis is denoted by αr, an angle between a line connecting the rear intersection and a point of the edge surface closest to the object side and the optical axis is denoted by βr, and units of αr and βr are degrees, the film is provided on 50% or more of a total area of the edge surfaces of all the rear lens components satisfying Conditional Expression (6), which is represented by 2.7°<αr−βr<40° (6).

### [Supplementary Note 9]

The optical system according to supplementary note 7 or 8, in which in a case in which an intersection between the lens surface of the optical system closest to the image side and the optical axis is defined as a rear intersection, M is defined as a natural number of 2 or more, and for an M-th rear lens component from the image side, an angle between a line connecting the rear intersection and a point of the edge surface closest to the image side and the optical axis is denoted by αr, an angle between a line connecting the rear intersection and a point of the edge surface closest to the object side and the optical axis is denoted by βr, units of αr and βr are degrees, and a composite focal length from the rear lens component closest to the image side to an (M−1)th rear lens component from the image side is denoted by fr, a proportion of an area on which the film is provided is 30% or less of a total area of the edge surfaces of all the rear lens components satisfying Conditional Expressions (7) and (8), which are represented by 1.1°<αr−βr≤2.7° (7), and −2.4<TD/fr (8).

### [Supplementary Note 10]

The optical system according to any one of supplementary notes 7 to 9, in which in a case in which an intersection between the lens surface of the optical system closest to the image side and the optical axis is defined as a rear intersection, M is defined as a natural number of 2 or more, and for an M-th rear lens component from the image side, an angle between a line connecting the rear intersection and a point of the edge surface closest to the image side and the optical axis is denoted by αr, an angle between a line connecting the rear intersection and a point of the edge surface closest to the object side and the optical axis is denoted by βr, units of αr and βr are degrees, and a paraxial curvature radius of a surface, which is closest to the object side, of the M-th rear lens component from the image side is denoted by Rr, a proportion of an area on which the film is provided is 30% or less of a total area of the edge surfaces of all the rear lens components satisfying Conditional Expressions (7) and (9), which are represented by 1.1°<αr−βr ≤ 2.7° (7), and −10<TD/Rr (9).

### [Supplementary Note 11]

The optical system according to any one of supplementary notes 7 to 10, in which in a case in which the lens component, in which at least a part of the lens component is located in a range of 0.3×TD from the lens surface of the optical system closest to the object side to the image side on the optical axis, among the lens components included in the optical system is defined as a front lens component, an intersection between the lens surface of the optical system closest to the object side and the optical axis is defined as a front intersection, for each of the front lens components, an angle between a line connecting the front intersection and a point of the edge surface closest to the object side and the optical axis is denoted by αf, an angle between a line connecting the front intersection and a point of the edge surface closest to the image side and the optical axis is denoted by βf, and units of αf and βf are degrees, an intersection between the lens surface of the optical system closest to the image side and the optical axis is defined as a rear intersection, and for each of the rear lens components, an angle between a line connecting the rear intersection and a point of the edge surface closest to the image side and the optical axis is denoted by αr, an angle between a line connecting the rear intersection and a point of the edge surface closest to the object side and the optical axis is denoted by βr, and units of αr and βr are degrees, a proportion of an area on which the film is provided is 30% or less of a total area of the edge surfaces of all the front lens components satisfying Conditional Expression (10) and the edge surfaces of all the rear lens components satisfying Conditional Expression (11), Conditional Expressions (10) and (11) being represented by 0°<αf−βf≤1.1° (10), and 0°<αr−βr≤1.1° (11).

### [Supplementary Note 12]

The optical system according to any one of supplementary notes 1 to 11, further comprising, in order from the object side to the image side, a first lens group having a positive refractive power and a subsequent group including at least one lens group, in which a spacing between adjacent lens groups changes during changing magnification.

### [Supplementary Note 13]

The optical system according to supplementary note 12, in which the subsequent group includes a second lens group having a negative refractive power at a position closest to the object side.

### [Supplementary Note 14]

The optical system according to supplementary note 12 or 13, in which the subsequent group includes, in successive order from the object side to the image side, a second lens group, a third lens group, and a fourth lens group, and at least the second lens group and the fourth lens group move during changing magnification.

### [Supplementary Note 15]

The optical system according to any one of supplementary notes 12 to 14, in which the subsequent group includes a focusing group that moves along the optical axis during focusing.

All of the documents, the patent applications, and the technical standards described in the present specification are incorporated in the present specification by reference to the same extent as in a case in which each of the documents, the patent applications, and the technical standards are specifically and individually described to be incorporated by reference.

What is claimed is:

1. An optical system comprising:
at least one lens component in a case in which one lens component is one single lens or one cemented lens,
wherein in a case in which
an outer peripheral surface of the lens component parallel to an optical axis is defined as an edge surface,
a distance, on the optical axis, from a lens surface of the optical system closest to an object side to a lens surface of the optical system closest to an image side is denoted by TD, and
the lens component, in which at least a part of the lens component is located in a range of 0.3×TD from the lens surface of the optical system closest to the object side to the image side on the optical axis, among the lens components included in the optical system is defined as a front lens component,
a film having a light reflectivity of less than 30% is provided on 50% or more of a total area of the edge surfaces of all the front lens components.

2. The optical system according to claim 1,
wherein in a case in which
an open F-number of the optical system in a state in which an infinite distance object is in focus is denoted by FNo,
a maximum half angle of view of the optical system in a state in which the infinite distance object is in focus is denoted by ω, and
FNo and ω are values at a wide angle end in a case in which the optical system is a variable magnification optical system,
Conditional Expression (1) is satisfied, which is represented by
$$1 < FNo / tan ω < 10. \qquad ( 1 )$$

3. The optical system according to claim 1,
wherein in a case in which
an intersection between the lens surface of the optical system closest to the object side and the optical axis is defined as a front intersection, and
for each of the front lens components, an angle between a line connecting the front intersection and a point of the edge surface closest to the object side and the optical axis is denoted by αf, an angle between a line connecting the front intersection and a point of the edge surface closest to the image side and the optical axis is denoted by βf, and units of αf and βf are degrees,
the film is provided on 50% or more of a total area of the edge surfaces of all the front lens components satisfying Conditional Expression (2), which is represented by
$$2.7 ° < α f - β f < 40 ° . \qquad ( 2 )$$

4. The optical system according to claim 1,
wherein in a case in which
an intersection between the lens surface of the optical system closest to the object side and the optical axis is defined as a front intersection,
N is defined as a natural number of 2 or more, and
for an N-th front lens component from the object side, an angle between a line connecting the front intersection and a point of the edge surface closest to the object side and the optical axis is denoted by αf, an angle between a line connecting the front intersection and a point of the edge surface closest to the image side and the optical axis is denoted by βf, units of αf and βf are degrees, and a composite focal length from the front lens component closest to the object side to an (N−1)th front lens component from the object side is denoted by ff,
a proportion of an area on which the film is provided is 30% or less of a total area of the edge surfaces of all the front lens components satisfying Conditional Expressions (3) and (4), which are represented by
$$1.1 ° < α f - β f \leq 2.7 ° , and \qquad ( 3 )$$
$$- 2.4 < TD / ff . \qquad ( 4 )$$

5. The optical system according to claim 1,
wherein in a case in which
an intersection between the lens surface of the optical system closest to the object side and the optical axis is defined as a front intersection,
N is defined as a natural number of 2 or more, and
for an N-th front lens component from the object side, an angle between a line connecting the front intersection and a point of the edge surface closest to the object side and the optical axis is denoted by αf, an angle between a line connecting the front intersection and a point of the edge surface closest to the image side and the optical axis is denoted by βf, units of αf and βf are degrees, and a paraxial curvature radius of a surface, which is closest to the image side, of the N-th front lens component from the object side is denoted by Rf,
a proportion of an area on which the film is provided is 30% or less of a total area of the edge surfaces of all the front lens components satisfying Conditional Expressions (3) and (5), which are represented by
$$1.1 ° < α f - β f \leq 2.7 ° , and \qquad ( 3 )$$
$$TD / Rf < 2.4 . \qquad ( 5 )$$

6. The optical system according to claim 1,
wherein in a case in which
an intersection between the lens surface of the optical system closest to the object side and the optical axis is defined as a front intersection,
for each of the front lens components, an angle between a line connecting the front intersection and a point of the edge surface closest to the object side and the optical axis is denoted by αf, an angle between a line connecting the front intersection and a point of the edge surface closest to the image side and the optical axis is denoted by βf, and units of αf and βf are degrees,
the lens component, in which at least a part of the lens component is located in a range of 0.3×TD from the lens surface of the optical system closest to the image side to the object side on the optical axis, among the lens components included in the optical system is defined as a rear lens component,
an intersection between the lens surface of the optical system closest to the image side and the optical axis is defined as a rear intersection, and
for each of the rear lens components, an angle between a line connecting the rear intersection and a point of the edge surface closest to the image side and the optical axis is denoted by αr, an angle between a line connecting the rear intersection and a point of the edge surface closest to the object side and the optical axis is denoted by βr, and units of αr and βr are degrees,
a proportion of an area on which the film is provided is 30% or less of a total area of the edge surfaces of all the front lens components satisfying Conditional Expression (10) and the edge surfaces of all the rear lens components satisfying Conditional Expression (11), Conditional Expressions (10) and (11) being represented by
$$0 ° < α f - β f \leq 1.1 ° , and \qquad ( 10 )$$
$$0 ° < α r - β r \leq 1.1 ° . \qquad ( 11 )$$

7. An optical system comprising:
at least one lens component in a case in which one lens component is one single lens or one cemented lens,
wherein in a case in which
an outer peripheral surface of the lens component parallel to an optical axis is defined as an edge surface,
a distance, on the optical axis, from a lens surface of the optical system closest to an object side to a lens surface of the optical system closest to an image side is denoted by TD, and
the lens component, in which at least a part of the lens component is located in a range of 0.3×TD from the lens surface of the optical system closest to the image side to the object side on the optical axis, among the lens components included in the optical system is defined as a rear lens component,
a film having a light reflectivity of less than 30% is provided on 50% or more of a total area of the edge surfaces of all the rear lens components.

8. The optical system according to claim 7,
wherein in a case in which
an intersection between the lens surface of the optical system closest to the image side and the optical axis is defined as a rear intersection, and
for each of the rear lens components, an angle between a line connecting the rear intersection and a point of the edge surface closest to the image side and the optical axis is denoted by αr, an angle between a line connecting the rear intersection and a point of the edge surface closest to the object side and the optical axis is denoted by βr, and units of αr and βr are degrees,
the film is provided on 50% or more of a total area of the edge surfaces of all the rear lens components satisfying Conditional Expression (6), which is represented by
$$2.7 ° < α r - β r < 40 ° . \qquad ( 6 )$$

9. The optical system according to claim 7,
wherein in a case in which
an intersection between the lens surface of the optical system closest to the image side and the optical axis is defined as a rear intersection,
M is defined as a natural number of 2 or more, and
for an M-th rear lens component from the image side, an angle between a line connecting the rear intersection and a point of the edge surface closest to the image side and the optical axis is denoted by αr, an angle between a line connecting the rear intersection and a point of the edge surface closest to the object side and the optical axis is denoted by βr, units of αr and βr are degrees, and a composite focal length from the rear lens component closest to the image side to an (M−1)th rear lens component from the image side is denoted by fr,
a proportion of an area on which the film is provided is 30% or less of a total area of the edge surfaces of all the rear lens components satisfying Conditional Expressions (7) and (8), which are represented by
$$1.1 ° < α r - β r \leq 2.7 ° , and \qquad ( 7 )$$
$$- 2.4 < TD / fr . \qquad ( 8 )$$

10. The optical system according to claim 7,
wherein in a case in which
an intersection between the lens surface of the optical system closest to the image side and the optical axis is defined as a rear intersection,
M is defined as a natural number of 2 or more, and
for an M-th rear lens component from the image side, an angle between a line connecting the rear intersection and a point of the edge surface closest to the image side and the optical axis is denoted by αr, an angle between a line connecting the rear intersection and a point of the edge surface closest to the object side and the optical axis is denoted by βr, units of αr and βr are degrees, and a paraxial curvature radius of a surface, which is closest to the object side, of the M-th rear lens component from the image side is denoted by Rr,
a proportion of an area on which the film is provided is 30% or less of a total area of the edge surfaces of all the rear lens components satisfying Conditional Expressions (7) and (9), which are represented by
$$1.1 ° < α r - β r \leq 2.7 ° , and \qquad ( 7 )$$
$$- 10 < TD / Rr . \qquad ( 9 )$$

11. The optical system according to claim 7,
wherein in a case in which
the lens component, in which at least a part of the lens component is located in a range of 0.3×TD from the lens surface of the optical system closest to the object side to the image side on the optical axis, among the lens components included in the optical system is defined as a front lens component,
an intersection between the lens surface of the optical system closest to the object side and the optical axis is defined as a front intersection,
for each of the front lens components, an angle between a line connecting the front intersection and a point of the edge surface closest to the object side and the optical axis is denoted by αf, an angle between a line connecting the front intersection and a point of the edge surface closest to the image side and the optical axis is denoted by βf, and units of αf and βf are degrees,
an intersection between the lens surface of the optical system closest to the image side and the optical axis is defined as a rear intersection, and
for each of the rear lens components, an angle between a line connecting the rear intersection and a point of the edge surface closest to the image side and the optical axis is denoted by αr, an angle between a line connecting the rear intersection and a point of the edge surface closest to the object side and the optical axis is denoted by βr, and units of αr and βr are degrees,
a proportion of an area on which the film is provided is 30% or less of a total area of the edge surfaces of all the front lens components satisfying Conditional Expression (10) and the edge surfaces of all the rear lens components satisfying Conditional Expression (11), Conditional Expressions (10) and (11) being represented by
$$0 ° < α f - β f \leq 1.1 ° , and \qquad ( 10 )$$
$$0 ° < α r - β r \leq 1.1 ° . \qquad ( 11 )$$

12. The optical system according to claim 1, further comprising, in order from the object side to the image side, a first lens group having a positive refractive power and a subsequent group including at least one lens group,
wherein a spacing between adjacent lens groups changes during changing magnification.

13. The optical system according to claim 12,
wherein the subsequent group includes a second lens group having a negative refractive power at a position closest to the object side.

14. The optical system according to claim 13,
wherein the subsequent group includes, in successive order from the object side to the image side, the second lens group, a third lens group, and a fourth lens group, and
at least the second lens group and the fourth lens group move during changing magnification.

15. The optical system according to claim 14,
wherein the subsequent group includes a focusing group that moves along the optical axis during focusing.

16. The optical system according to claim 7, further comprising, in order from the object side to the image side, a first lens group having a positive refractive power and a subsequent group including at least one lens group,
wherein a spacing between adjacent lens groups changes during changing magnification.

17. The optical system according to claim 16,
wherein the subsequent group includes a second lens group having a negative refractive power at a position closest to the object side.

18. The optical system according to claim 17,
wherein the subsequent group includes, in successive order from the object side to the image side, the second lens group, a third lens group, and a fourth lens group, and
at least the second lens group and the fourth lens group move during changing magnification.

19. The optical system according to claim 18,
wherein the subsequent group includes a focusing group that moves along the optical axis during focusing.
